(19) United States
(12) Patent Application Publication
(10) Pub. No.: US 2022/0293073 A1
(43) Pub. Date: Sep. 15, 2022

(54) SIGNAL PROCESSING DEVICE, SIGNAL PROCESSING METHOD, AND PROGRAM

(71) Applicant: SONY GROUP CORPORATION, TOKYO (JP)

(72) Inventor: HEESOON KIM, TOKYO (JP)

(21) Appl. No.: 17/635,073

(22) PCT Filed: Aug. 11, 2020
(86) PCT No.: PCT/JP2020/030560

§ 371 Date: Feb. 14, 2022

(30) Foreign Application Priority Data
Aug. 22, 2019 (JP) 2019-152123

(51) Int. Cl. G10H 1/00

(52) U.S. Cl. CPC G10H 1/0008; G10H 2210/241; G10H 2220/201; G10H 2220/321

(57) ABSTRACT

The present technology relates to a signal processing device, a signal processing method, and a program that enable intuitive operation of sound.

The signal processing device includes an acquisition unit that acquires a sensing value indicating a motion of a predetermined portion of a body of a user or motion of an instrument, and a control unit that performs non-linear acoustic processing on an acoustic signal according to the sensing value. The present technology can be applied to an acoustic reproduction system.

### TECHNICAL FIELD

The present technology relates to a signal processing device, a signal processing method, and a program, in particular, to a signal processing device, a signal processing method, and a program that enable intuitive operation of sound.

### BACKGROUND ART

Conventionally, technology for operating sound in accordance with a motion of a body of a user has been proposed (refer to Patent Document 1, for example).

For example, in Patent Document 1, because effect processing is executed on the basis of an output waveform of a sensor attached to a user, when the user moves an attachment portion of the sensor, sound reproduced in accordance with the motion changes.

Furthermore, by using such technology, for example, a DJ can change volume or the like of sound being reproduced, that is, can operate sound, by moving an arm of the DJ so that the arm flaps up and down.

### CITATION LIST

### Patent Document

Patent Document 1: WO 2017/061577

### SUMMARY OF THE INVENTION

### Problems to be Solved by the Invention

However, it has been difficult for the user to intuitively operate sound with the above-described technology, because intention of the user cannot be sufficiently reflected in operation of sound even if an output waveform of a sensor is directly applied to a parameter to operate the sound.

The present technology has been developed in view of the above circumstances, and is to enable intuitive operation of sound.

### Solutions to Problems

A signal processing device according to one aspect of the present technology includes an acquisition unit that acquires a sensing value indicating a motion of a predetermined portion of a body of a user or motion of an instrument, and a control unit that performs non-linear acoustic processing on an acoustic signal according to the sensing value.

A signal processing method or program according to one aspect of the present technology includes steps of acquiring a sensing value indicating a motion of a predetermined portion of a body of a user or motion of an instrument, and performing non-linear acoustic processing on an acoustic signal according to the sensing value.

In one aspect of the present technology, a sensing value indicating a motion of a predetermined portion of a body of a user or motion of an instrument is acquired, and non-linear acoustic processing is performed on an acoustic signal according to the sensing value.

### BRIEF DESCRIPTION OF DRAWINGS

FIG. 1 is a diagram illustrating a configuration example of an acoustic reproduction system.

FIG. 2 is a diagram illustrating a configuration example of the acoustic reproduction system.

FIG. 3 is a diagram illustrating a configuration example of an information terminal device.

FIG. 4 is a diagram illustrating an example of a sensitivity curve.

FIG. 5 is a flowchart describing reproduction processing.

FIG. 6 is a diagram illustrating an example of the sensitivity curve.

FIG. 7 is a diagram illustrating examples of the sensitivity curve.

FIG. 8 is a diagram illustrating examples of the sensitivity curve.

FIG. 9 is a diagram illustrating examples of the sensitivity curve.

FIG. 10 is a diagram for describing an example of a motion of a user and acoustic effect.

FIG. 11 is a diagram for describing an example of a motion of the user and acoustic effect.

FIG. 12 is a diagram for describing an example of a motion of the user and acoustic effect.

FIG. 13 is a diagram for describing an example of a motion of the user and acoustic effect.

FIG. 14 is a diagram for describing an example of detection of the motion of the user.

FIG. 15 is a diagram for describing an example of detection of the motion of the user.

FIG. 16 is a diagram for describing an example of a motion of the user and acoustic effect.

FIG. 17 is a diagram for describing an example of a motion of the user and acoustic effect.

FIG. 18 is a diagram for describing an example of a motion of the user and acoustic effect.

FIG. 19 is a diagram for describing an example of a motion of the user and acoustic effect.

FIG. 20 is a diagram for describing an example of a motion of the user and acoustic effect.

FIG. 21 is a diagram for describing an example of a motion of the user and acoustic effect.

FIG. 22 is a diagram for describing an example of a motion of the user and acoustic effect.

FIG. 23 is a flowchart describing selection processing.

FIG. 24 is a diagram illustrating an example of a selection screen for a sensitivity curve.

FIG. 25 is a flowchart describing selection processing.

FIG. 26 is a diagram illustrating examples of a motion of the user and sensitivity curve.

FIG. 27 is a flowchart describing drawing processing.

FIG. 28 is a diagram illustrating an example of a sensitivity curve input screen.

FIG. 29 is a diagram illustrating an example of an animation curve.

FIG. 30 is a diagram illustrating an example of an animation curve.

FIG. 31 is a flowchart describing reproduction processing.

FIG. 32 is a diagram illustrating an example of an animation curve.

FIG. 33 is a diagram illustrating an example of an animation curve.

FIG. 34 is a flowchart describing reproduction processing.

FIG. 35 is a diagram illustrating a configuration example of a computer.

### MODE FOR CARRYING OUT THE INVENTION

Hereinafter, embodiments to which the present technology is applied will be described with reference to the drawings.

### First Embodiment

<Configuration Example of Acoustic Reproduction System>

The present technology enables intuitive operation of sound by a user by performing, on the basis of a result of detecting a motion of the user, non-linear acoustic processing on an acoustic signal to be reproduced, in a case where sound is changed according to a motion of a body of the user.

For example, a case where a DJ operates sound by moving an arm of the DJ up and down will be considered.

In this case, in many situations, the arm is moved most frequently and quickly in a range in an upward direction as viewed from the DJ, for example, in a range where an angle by which the arm is moved in the upward direction from a state where the arm protrudes to a front (horizontal state) is 45 degrees or more.

Therefore, the DJ should be able to intuitively operate the sound if an amount of change in sound increases when the arm of the DJ is above, and the amount of change in the sound decreases when the arm of the DJ is below.

However, for example, in a case where an output waveform of a sensor attached to the arm of the DJ is directly applied to a parameter, and acoustic processing such as effect processing is performed on an acoustic signal on the basis of the parameter, the sound changes linearly with respect to a change in a position (height) of the arm of the DJ regardless of whether the arm of the DJ is above or below. Then, a gap is generated between a change in the sound that the DJ expects when moving the arm and a change in actual sound, and therefore, intuitive operation is difficult.

Furthermore, for example, in a case where the sound is changed by performing threshold processing on the position of the arm of the DJ and by, according to a result of the threshold processing, performing acoustic processing on an acoustic signal to be reproduced, a change in the sound is discrete, and therefore, not only the intuitive operation is difficult but also expression by operation of the sound is restricted.

Therefore, in the present technology, non-linear acoustic processing is performed on an acoustic signal to be reproduced according to a motion of the user.

Specifically, for example, in the present technology, a function of a specific curve or polygonal line, which has a sensing value of a motion of the user as input and sensitivity corresponding to the sensing value at a time of operation of sound as output, is previously obtained by interpolation processing, and acoustic processing is performed with a parameter corresponding to an output value of the function.

In this way, a degree of change in sound to be operated, that is to say sensitivity in operation of the sound, is dynamically changed according to magnitude of a motion of the user such as an angle or position of, or speed or intensity of a motion of a body portion of the user, and the user can perform intuitive operation of the sound. In other words, the user can easily reflect intention of own when operating the sound.

Hereinafter, the present technology will be described more specifically.

First, an acoustic reproduction system to which the present technology is applied will be described.

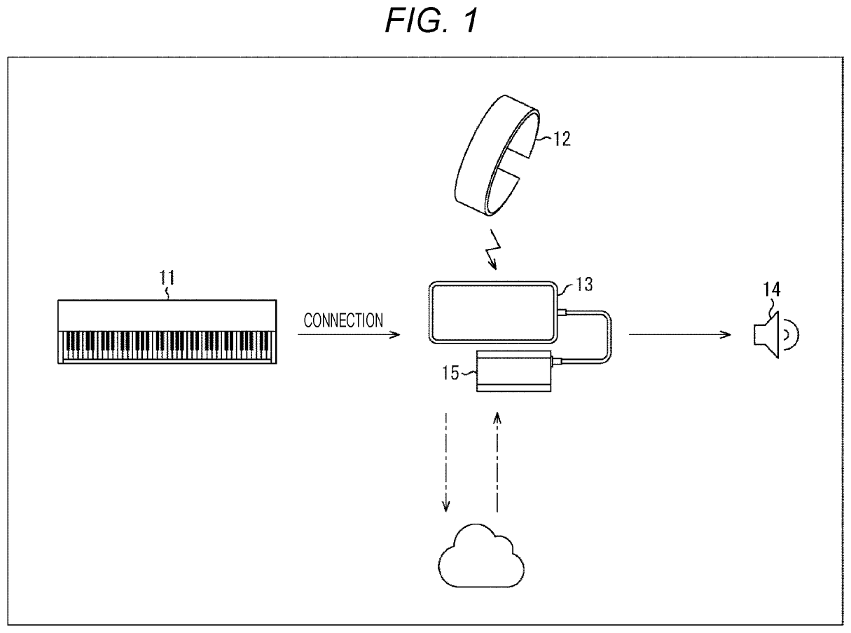

The acoustic reproduction system to which the present technology is applied has, for example, as illustrated in FIG. 1, a musical instrument 11 played by the user, a wearable device 12 attached to a predetermined portion of the user, an information terminal device 13, a speaker 14, and an audio interface 15.

In this example, for example, the musical instrument 11, the information terminal device 13, and the speaker 14 are connected by the audio interface 15, and if the user plays the musical instrument 11, sound corresponding to the playing is reproduced by the speaker 14. At this time, the reproduced playing sound changes according to a motion of the user.

Note that the musical instrument 11 may be any instrument such as, for example, a keyboard musical instrument such as a piano or a keyboard, a string musical instrument such as a guitar or a violin, a percussion musical instrument such as a drum, a wind musical instrument, or an electronic musical instrument such as a track pad.

Furthermore, the wearable device 12 is an apparatus that can be attached to any portion, such as an arm, of the user, and includes various sensors such as an acceleration sensor, a gyro sensor, a microphone, an electromyograph, a pressure sensor, or a bending sensor.

With the sensor, the wearable device 12 detects a motion of the user, more specifically, a motion of an attachment portion of the wearable device 12 of the user, and supplies a sensing value indicating a result of the detection to the information terminal device 13 by wireless or wired communication.

Note that, here, an example of detecting a motion of the user by the wearable device 12 will be described. However, not limited to this, the motion of the user may be detected by a sensor, such as a camera or an infrared sensor, that is disposed around the user in a state of not being attached to the user, or such a sensor may be provided on the musical instrument 11.

Furthermore, such a sensor disposed around the user and the wearable device 12 may be combined to detect the motion of the user.

The information terminal device 13 is, for example, a signal processing device such as a smartphone or a tablet. Note that, not limited to this, the information terminal device 13 may be any signal processing device such as a personal computer.

In the acoustic reproduction system illustrated in FIG. 1, for example, while playing the musical instrument 11 with the wearable device 12 attached to the user, the user performs a desired motion (action) for achieving a change in sound that the user desires to express in accordance with the playing. The motion mentioned here is, for example, a motion such as raising or lowering an arm or waving a hand.

Then, an acoustic signal for reproducing playing sound is supplied from the musical instrument 11 to the information terminal device 13 via the audio interface 15.

Note that, here, description will be given assuming that the audio interface 15 is an ordinary audio interface that inputs and outputs an acoustic signal for reproducing the playing sound. However, the audio interface 15 may be an MIDI interface or the like that inputs and outputs an MIDI signal that indicates height of the playing sound.

Furthermore, in the wearable device 12, a motion of the user during the playing is detected, and a sensing value obtained as a result is supplied to the information terminal device 13.

Then, on the basis of the sensing value supplied from the wearable device 12 and a previously prepared conversion function representing a sensitivity curve, the information terminal device 13 calculates an acoustic parameter for acoustic processing to be performed on the acoustic signal. This acoustic parameter changes non-linearly with respect to the sensing value.

The information terminal device 13 performs, on the basis of the obtained acoustic parameter, acoustic processing on the acoustic signal supplied from the musical instrument 11 via the audio interface 15, and supplies a reproduction signal obtained as a result to the speaker 14 via the audio interface 15.

The speaker 14 outputs sound on the basis of the reproduction signal supplied from the information terminal device 13 via the audio interface 15. With this arrangement, sound to which an acoustic effect, such as an effect corresponding to a motion of the user, is added to the sound of playing the musical instrument 11 is reproduced.

Here, the sensitivity curve is a non-linear curve or polygonal line indicating a sensitivity characteristic for when operation on the playing sound, that is to say addition of acoustic effect, is performed by the motion of the user, and a function representing the sensitivity curve is a conversion function.

In this example, for example, the sensing value indicating a result of detecting the motion of the user is substituted into the conversion function, and calculation is performed.

Then, as a calculation result, that is, an output value of the conversion function (hereinafter, referred to as a function output value), a value indicating a degree of intensity (magnitude) of the acoustic effect added to the motion of the user, that is to say sensitivity, is obtained.

Moreover, in the information terminal device 13, an acoustic parameter is calculated on the basis of the function output value, and acoustic processing of adding an acoustic effect is performed on the basis of the obtained acoustic parameter.

For example, an acoustic effect added to an acoustic signal is various effects such as delay, pitch bend, panning, or volume change by gain correction.

Therefore, for example, when a pitch bend is added as an acoustic effect, the acoustic parameter is a value indicating a shift amount of pitch (pitch) at a time of the pitch bend.

In the acoustic processing, non-linear acoustic processing can be achieved by using the acoustic parameter obtained from a function output value of a conversion function representing a non-linear sensitivity curve. That is to say, sensitivity can be dynamically changed according to a motion of a body of the user.

With this arrangement, intention of the user can be sufficiently reflected, and the user can perform intuitive operation of the sound, that is to say addition of the acoustic effect, while playing the musical instrument 11, or the like.

Note that the conversion function may be previously prepared, or the user may create a desired motion and a conversion function that adds a new acoustic effect corresponding to the motion.

In such a case, for example, the information terminal device 13 may download the previously prepared desired conversion function from a server or the like via a wired or wireless network, or upload, to the server or the like, a thing obtained by associating the conversion function created by the user with information indicating the motion.

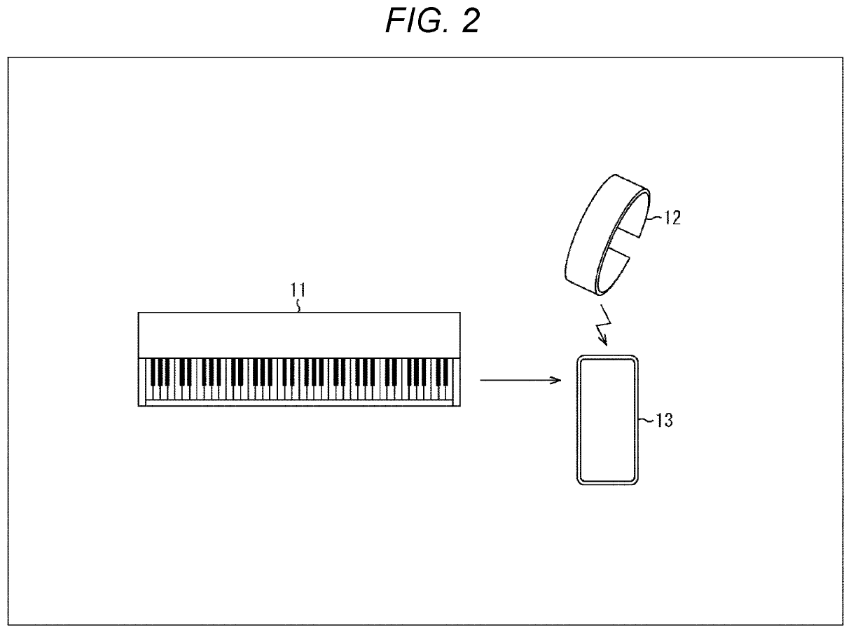

In addition, the acoustic reproduction system to which the present technology is applied may have a configuration illustrated in FIG. 2, or the like, for example. Note that, in FIG. 2, the parts corresponding to the parts in FIG. 1 are provided with the same reference signs, and description of the corresponding parts will be omitted as appropriate.

In the example illustrated in FIG. 2, the musical instrument 11 and the information terminal device 13 are connected wirelessly or by wire such as an audio interface or a MIDI interface, and the information terminal device 13 and the wearable device 12 are connected wirelessly or by wire.

In this case, for example, the information terminal device 13 receives an acoustic signal supplied from the musical instrument 11, performs acoustic processing on the acoustic signal on the basis of the acoustic parameter obtained from the sensing value supplied from the wearable device 12, and generates a reproduction signal. Then, the information terminal device 13 reproduces sound on the basis of the generated reproduction signal.

In addition, the sound may be reproduced on a side of the musical instrument 11. In such a case, for example, the information terminal device 13 may supply the musical instrument 11 with an MIDI signal corresponding to the reproduction signal to reproduce sound, or the information terminal device 13 may transmit a sensing value, the acoustic parameter, or the like to the musical instrument 11, and acoustic processing may be performed at on the side of the musical instrument 11.

Note that, hereinafter, description will be given assuming that the information terminal device 13 receives an acoustic signal supplied from the musical instrument 11, and sound is reproduced in the information terminal device 13 on the basis of a reproduction signal.

<Configuration Example of Information Terminal Device>

Next, a configuration example of the information terminal device 13 illustrated in FIGS. 1 and 2 will be described.

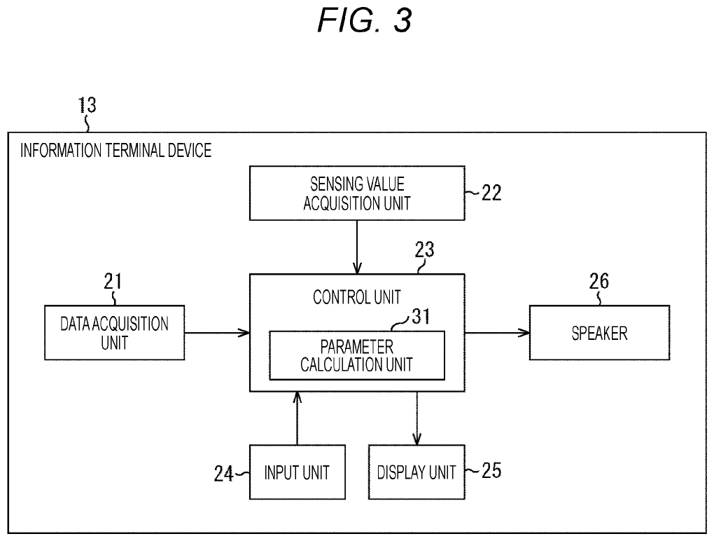

The information terminal device 13 is configured as illustrated in FIG. 3, for example.

The information terminal device 13 illustrated in FIG. 3 has a data acquisition unit 21, a sensing value acquisition unit 22, a control unit 23, an input unit 24, a display unit 25, and a speaker 26.

The data acquisition unit 21 is connected to the musical instrument 11 by wire or wirelessly, acquires an acoustic signal output from the musical instrument 11, and supplies the acoustic signal to the control unit 23.

Note that, although a case where the acoustic signal to be reproduced is sound of playing the musical instrument 11 will be described here as an example, not limited to this, an acoustic signal of any sound may be acquired as a reproduction target by the data acquisition unit 21.

Therefore, for example, in a case where an acoustic signal of predetermined music or the like previously recorded is acquired by the data acquisition unit 21, acoustic processing of adding an acoustic effect to the acoustic signal is performed, and music or the like to which the acoustic effect is added is reproduced.

In addition, for example, the acoustic signal to be reproduced may be a signal of sound of the acoustic effect, that is, a sound effect (effect sound) itself, and a degree of effect in the sound effect may change according to the motion of the user. Moreover, a sound effect with which intensity of the effect (effect) changes according to the motion of the user may be reproduced together with the sound of playing the musical instrument 11.

The sensing value acquisition unit 22 is connected to the wearable device 12 by wire or wirelessly, acquires, from the wearable device 12, a sensing value indicating a motion of an attachment portion of the wearable device 12 on the user, and supplies the sensing value to the control unit 23.

Note that the sensing value acquisition unit 22 may acquire, from a sensor provided on an instrument such as the musical instrument 11 played by the user, a sensing value indicating a motion of the instrument, in other words, a motion of the user who handles the instrument.

The control unit 23 controls operation of the entire information terminal device 13. Furthermore, the control unit 23 has a parameter calculation unit 31.

The parameter calculation unit 31 calculates the acoustic parameter on the basis of the sensing value supplied from the sensing value acquisition unit 22 and a previously held conversion function.

On the acoustic signal supplied from the data acquisition unit 21, the control unit 23 performs non-linear acoustic processing based on the acoustic parameter calculated by the parameter calculation unit 31, and supplies the speaker 26 with a reproduction signal obtained as a result.

The input unit 24 includes, for example, a touch panel, a button, a switch, or the like superimposed on the display unit 25, and supplies the control unit 23 with a signal corresponding to operation by the user.

The display unit 25 includes, for example, a liquid crystal display panel or the like, and displays various images under control of the control unit 23. The speaker 26 reproduces sound on the basis of the reproduction signal supplied from the control unit 23.

<About Sensitivity Curve>

Here, a conversion function used for calculation of the acoustic parameter, that is to say a sensitivity curve represented by the conversion function, will be described.

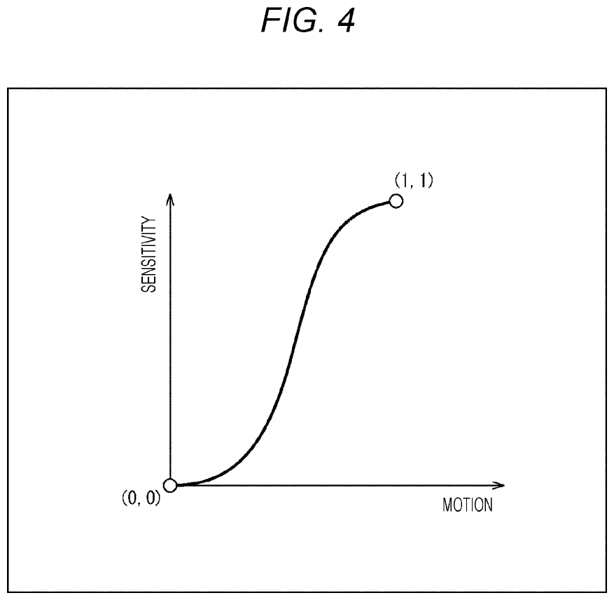

For example, the sensitivity curve is a non-linear curve, or the like as illustrated in FIG. 4. Note that, in FIG. 4, the horizontal axis represents a motion of the user, that is to say a sensing value, and the vertical axis represents sensitivity, that is to say a function output value.

In particular, in a range where the sensing value is small and a range where the sensing value is large in the example illustrated in FIG. 4, a change in sensitivity to a change in the sensing value is also great, and the conversion function is a non-linear function.

Furthermore, in this example, the function output value obtained by substituting the sensing value into the conversion function is set to a value between 0 and 1.

Such a sensitivity curve can be obtained, for example, by specifying two or more combinations of a predetermined point, that is to say a sensing value, and sensitivity (function output value) corresponding to the sensing value, and performing interpolation processing on the basis of the specified points and a specific Bezier curve. That is to say, interpolation is performed between each of the two or more points determined for the specified points on the basis of the Bezier curve, and a sensitivity curve is obtained.

Therefore, in a case where a conversion function representing such a sensitivity curve is used, an acoustic parameter changes non-linearly along the sensitivity curve. That is to say, an amount of change in the sound of playing the musical instrument 11 can be dynamically changed along the sensitivity curve according to a motion of the user.

For example, the sensitivity can be seamlessly changed by connecting a range in which sensitivity to a change in the sound in response to a motion of the user is desired to be low and a range in which the sensitivity is desired to be high, in a range of values that may be taken as sensing values, or the like.

Moreover, a range of expression of music by the user can be extended if a sensitivity curve is used, because sound can be changed non-linearly and continuously unlike a case where the sound is changed discretely by threshold processing.

<Description of Reproduction Processing>

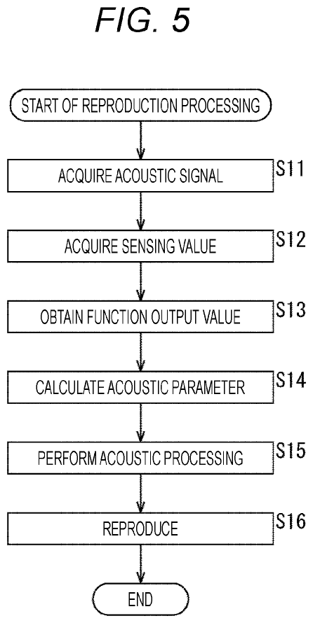

Next, operation of the information terminal device 13 will be described. That is to say, hereinafter, reproduction processing by the information terminal device 13 will be described with reference to the flowchart in FIG. 5.

The reproduction processing is started when the user with the wearable device 12 attached plays the musical instrument 11 while performing a desired motion as appropriate.

In Step S11, the data acquisition unit 21 acquires an acoustic signal output from the musical instrument 11 and supplies the acoustic signal to the control unit 23.

In Step S12, the sensing value acquisition unit 22 acquires a sensing value indicating a motion (motion) of the user and supplies the sensing value to the control unit 23 by receiving a sensing value from the wearable device 12 by wireless communication or the like.

In Step S13, the parameter calculation unit 31 substitutes the sensing value supplied from the sensing value acquisition unit 22 into a previously held conversion function and performs calculation to obtain a function output value.

Note that, for a plurality of motions of the user, the parameter calculation unit 31 may hold conversion functions corresponding to the respective motions, and a conversion function corresponding to a motion indicated by the sensing value may be used in Step S13.

In addition, for example, the function output value may be obtained by using a conversion function selected from among the plurality of previously held conversion functions by the user or the like operating the input unit 24 in advance.

In Step S14, the parameter calculation unit 31 calculates an acoustic parameter on the basis of the function output value obtained in Step S13.

For example, the parameter calculation unit 31 calculates the acoustic parameter by performing scale conversion on the function output value into a scale of the acoustic parameter. Therefore, the acoustic parameter changes non-linearly according to the sensing value.

In this case, because the function output value can be said to be a normalized acoustic parameter, the conversion function can be said to be a function having a motion (motion amount) of the user as input and an amount of change in sound due to the acoustic effect, that is to say the acoustic parameter, as an output.

In Step S15, the control unit 23 generates a reproduction signal by, on the basis of the acoustic parameter obtained in Step S14, performing non-linear acoustic processing on the acoustic signal acquired in Step S11 and supplied from the data acquisition unit 21.

In Step S16, the control unit 23 supplies the speaker 26 with the reproduction signal obtained in Step S15 to reproduce sound, and the reproduction processing ends.

By the sound based on the reproduction signal being output in the speaker 26, the sound of playing the musical instrument 11 to which the acoustic effect is added according to the motion (motion) of the user is reproduced.

As described above, the information terminal device 13 calculates the acoustic parameter on the basis of the sensing value and the conversion function representing the non-linear sensitivity curve, and performs non-linear acoustic processing on the acoustic signal on the basis of the acoustic parameter. In this way, sensitivity of the sound operation can be dynamically changed, and the user can intuitively operate the sound.

<Another Example of Sensitivity Curve>

Note that the sensitivity curve represented by the conversion function is not limited to the example illustrated in FIG. 4, and may be any other sensitivity curve as long as the sensitivity curve is a non-linear curve or polygonal line.

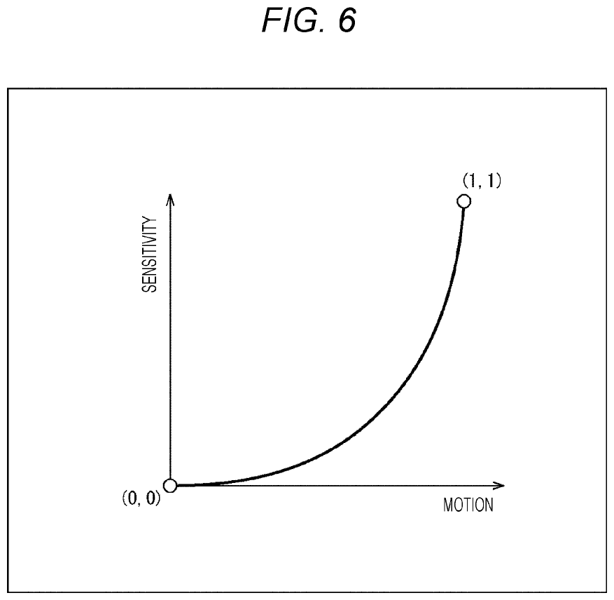

For example, the sensitivity curve can be an exponential function curve as illustrated in FIG. 6. Note that, in FIG. 6, the horizontal axis represents a motion of a body of the user, that is to say a sensing value, and the vertical axis represents sensitivity, that is to say a function output value.

The sensitivity curve illustrated in FIG. 6 can be obtained by interpolation processing based on a Bezier curve, similarly to the example illustrated in FIG. 4 for example, and in this example, the conversion function representing the sensitivity curve is an exponential function.

In such a sensitivity curve, sensitivity, that is to say a function output value, decreases as a motion of the user becomes smaller, and conversely, the function output value increases as the motion of the user becomes greater.

Furthermore, the motion of the body of the user input to the conversion function, that is to say a sensing value, can be, for example, acceleration in a direction of each axis of an x axis, a y axis, and a z axis of the user in a three-dimensional xyz space, combined acceleration of these accelerations, jerk of the motion of the user, a rotation angle (inclination) of the user with each axis of the x axis, the y axis, and the z axis as a rotation axis, or the like.

In addition, the sensing value can be a sound pressure level of or each frequency component of aerodynamic sound generated by the motion of the user, main frequency of the aerodynamic sound, a moving distance of the user, a contraction state of muscle measured by an electromyograph, pressure at which the user presses a keyboard or the like, or the like.

A non-linear conversion function indicating a sensitivity curve can be obtained by performing interpolation processing by appropriately using a curve such as a Bezier curve so that sensitivity changes non-linearly according to magnitude of the sensing value indicating the motion, such as rotation or movement, of the user obtained in this manner.

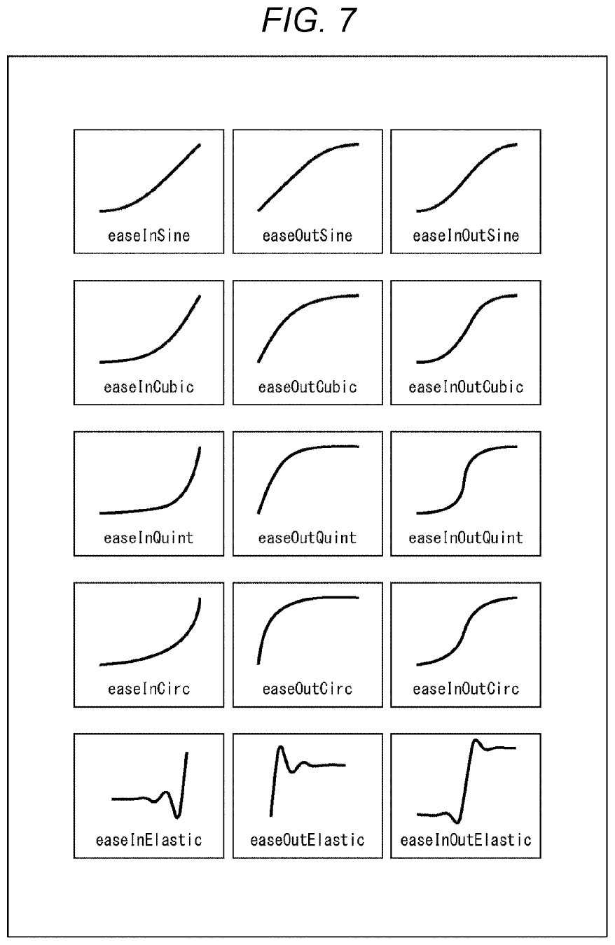

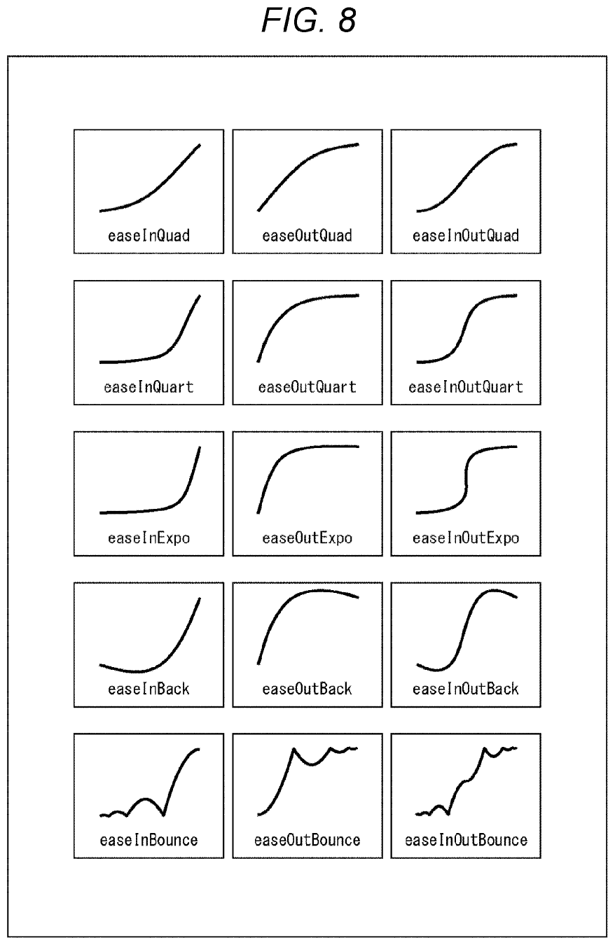

In addition, curves as illustrated in FIGS. 7 and 8 may be used as sensitivity curves obtained by interpolation processing based on a Bezier curve.

Note that, in FIGS. 7 and 8, each of the curves represents a sensitivity curve, and a name of the curve as a sensitivity curve is written on the lower side of each of diagrams of the sensitivity curves. Furthermore, in each of the sensitivity curves, a horizontal direction (horizontal axis) indicates a motion of the user, and a vertical direction (vertical axis) indicates sensitivity.

By utilizing such sensitivity curves (conversion functions) illustrated in FIGS. 7 and 8, an amount of change in playing sound can be curvilinearly (non-linearly) changed according to a motion of the user.

In particular, even with some of the sensitivity curves illustrated in FIGS. 7 and 8 having similar shapes, a manner of changing in sensitivity varies depending on an angle of a curved portion on each of the sensitivity curves, or the like.

For example, when a type of curve called easeIn in which “easeIn” is included in the name of the curve is used as the sensitivity curve, an amount of change in sound decreases as the motion of the body of the user becomes smaller, and the amount of change in the sound increases as the motion of the body of the user becomes greater.

Conversely, for example, when a type of curve called easeOut in which “easeOut” is included in the name of the curve is used, an amount of change in the sound increases as the motion of the body of the user becomes smaller, and the amount of change in the sound decreases as the motion of the body of the user becomes greater.

As described above, depending on an angle or start position of a curved portion, even curves having similar shapes have different position where sensitivity greatly changes or an amount the change.

Furthermore, when a type of curve called easeInOut is used, the amount of change in the sound is small in a range where the motion of the body of the user is small, the amount of change in the sound rapidly becomes large when the motion of the body of the user is moderate, and the amount of change in the sound is small in a range where the motion of the body of the user is greater.

When a type of curve called Elastic is used, it is possible to express sound as if the sound extends or contracts according to a change in the motion of the body of the user, and when a type of curve called Bounse is used, it is possible to express sound as if the sound bounces (bounds) according to a change in the motion of the body of the user.

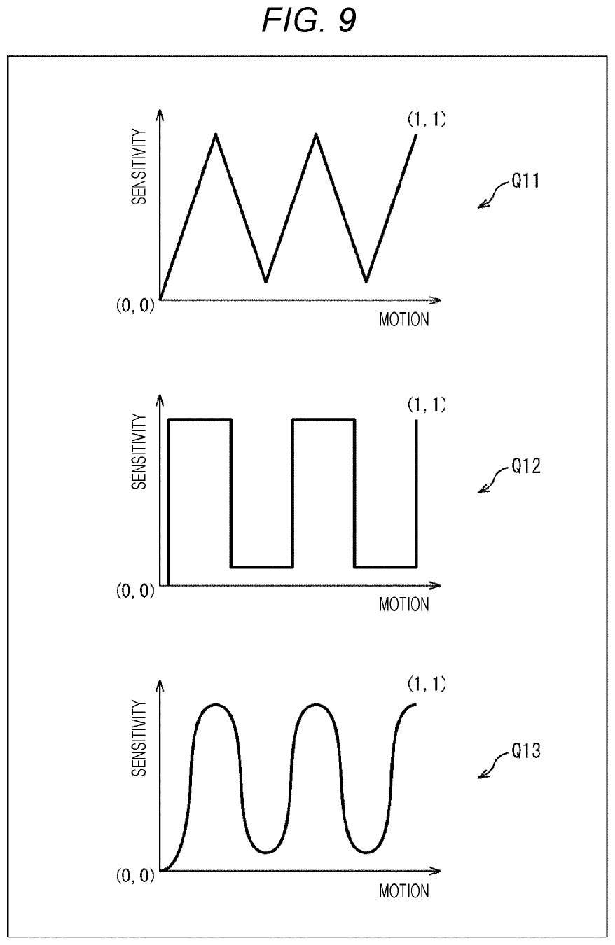

In addition, other than a curve obtained by interpolation processing using the Bezier curve, for example, any non-linear curve or polygonal line, such as polygonal lines or curves illustrated in FIG. 9, can be used as the sensitivity curve.

Note that, in FIG. 9, the horizontal axis represents a motion of the user, that is to say a sensing value, and the vertical axis represents sensitivity, that is to say a function output value.

For example, the sensitivity curve is a polygonal line having a triangular waveform in the example indicated by the arrow Q11, and the sensitivity curve is a polygonal line having a rectangular waveform in the example indicated by the arrow Q12. Moreover, the sensitivity curve is a periodic sinusoidal curve in the example indicated by the arrow Q13.

<Example of Motion and Acoustic Effect>

Moreover, specific examples of a motion (motion) of the user described above and an acoustic effect added according to the motion will be described.

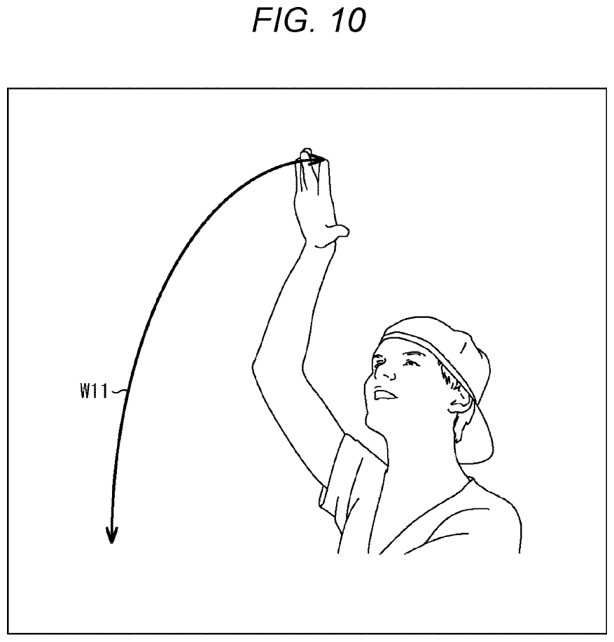

For example, as illustrated in FIG. 10, when a DJ who is the user makes a motion of moving a hand (arm) of the user in a vertical direction, that is to say in a direction indicated by the arrow W11, sound based on an acoustic signal can be changed. An angle by which the user moves the arm can be detected (measured) by, for example, a gyro sensor provided in the wearable device 12, or the like.

In this case, for example, an acoustic effect to be performed on the acoustic signal can be a delay effect called an echo effect achieved by a delay filter, a filter effect achieved by low-frequency cutoff using a cut-off filter, or the like.

In such a case, in the control unit 23, filtering processing by the delay filter or the cut-off filter is performed as non-linear acoustic processing.

In particular, in this case, if a conversion function representing a sensitivity curve of easeIn illustrated in FIGS. 7 and 8 is used, a change in delay or the like of sound, that is, a degree of application of an acoustic effect, decreases as an angle by which the user moves the arm decreases, that is to say the angle of the arm comes closer to a horizontal state. In other words, a so-called dry component increases, and a wet component decreases. Conversely, as the angle of the arm of the user increases, the change in sound increases.

Furthermore, conversely, the change in the sound may increase as the angle of the arm of the user decreases, and the change in the sound may decrease as the angle of the arm of the user increases.

Moreover, for example, as illustrated in FIG. 11, when a DJ who is the user makes a motion of moving a hand (arm) of the user in a lateral direction, that is to say in a direction indicated by the arrow W21, sound based on an acoustic signal may be changed.

At this time, for example, according to a position of an arm of the user in the lateral direction, an effect of laterally panning a sound image position of sound based on the acoustic signal, or the like, may be added as an acoustic effect. In particular, in this case, it is conceivable to pan a sound source (sound) to a greater extent, that is to say, to move the sound image position to a greater extent, as the angle of the arm of the user in the lateral direction increases. Furthermore, conversely, the sound may be panned to a greater extent as the angle of the arm of the user in the lateral direction decreases.

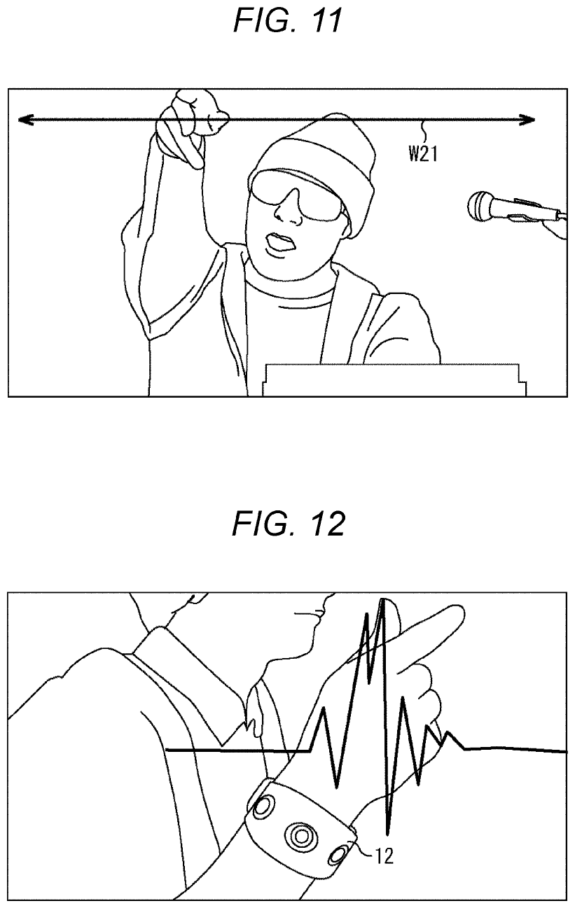

Moreover, for example, as illustrated in FIG. 12, when the user performs snap action as motion with a finger of the user, an effect such as reverb, distortion, or pitch bend, that is to say an acoustic effect, may be added to the acoustic signal.

In this case, the snap action by the user can be detected by sensing vibration, that is to say jerk, applied to the wearable device 12 attached to a wrist or the like of the user at a time of the snap action.

Then, in the information terminal device 13, acoustic processing such as filtering processing of adding an effect is performed on the basis of a sensing value of the jerk, so that an amount of change in an effect (acoustic effect), such as reverb, changes.

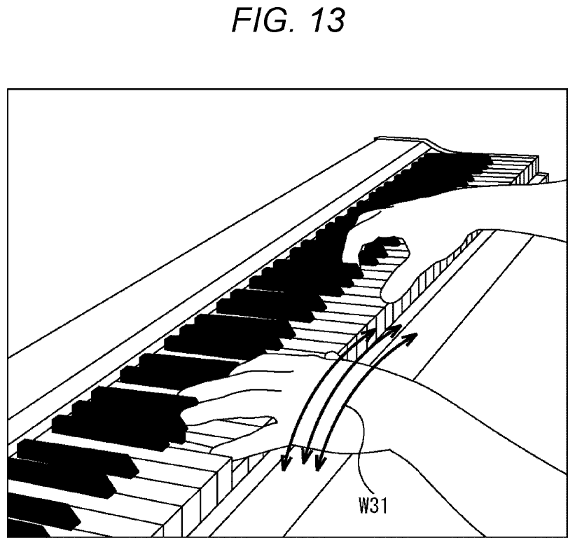

In addition, for example, as illustrated in FIG. 13, when the user performs an action of rocking a finger or arm of the user in the lateral direction, that is to say the direction indicated by the arrow W31, as a motion while playing a keyboard musical instrument such as a piano as the musical instrument 11, an effect (acoustic effect) such as pitch bend or vibrato may be added.

In this case, for example, the motion of rocking the arm in the lateral direction is detected by an acceleration sensor or the like provided in the wearable device 12 attached to the wrist or the like of the user, and the acoustic effect is added on the basis of an acceleration value as the sensing value obtained as the detection result.

Specifically, for example, as an acceleration value as the sensing value increases, a pitch shift amount in pitch bend as the acoustic effect can increase, and conversely, as the acceleration value decreases, the pitch shift amount can decrease. In this example, a pitch shift amount in the pitch bend is treated as the acoustic parameter.

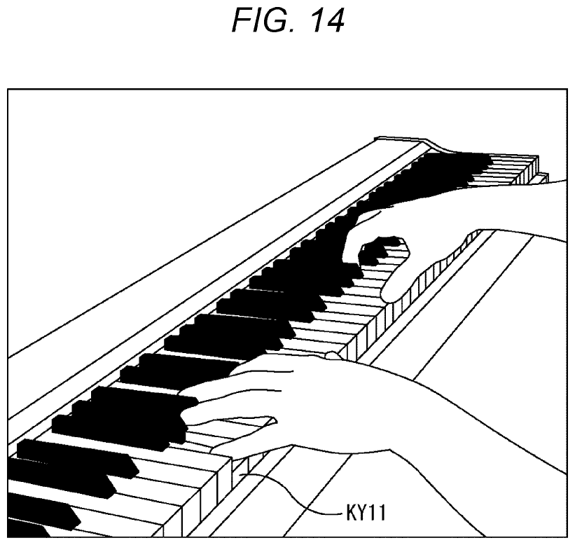

Furthermore, in the example in FIG. 13, a rocking of the arm (finger) of the user in the lateral direction as a motion may be detected by, as illustrated in FIG. 14 for example, a pressure sensor provided in each keyboard portion, such as a keyboard KY11 portion of a piano as the musical instrument 11.

In this case, from an output value of the pressure sensor provided in each keyboard portion, it is possible to identify which keyboard is pressed at each time (timing), and it is possible to detect the rocking of the arm of the user in the lateral direction on the basis of the identified result.

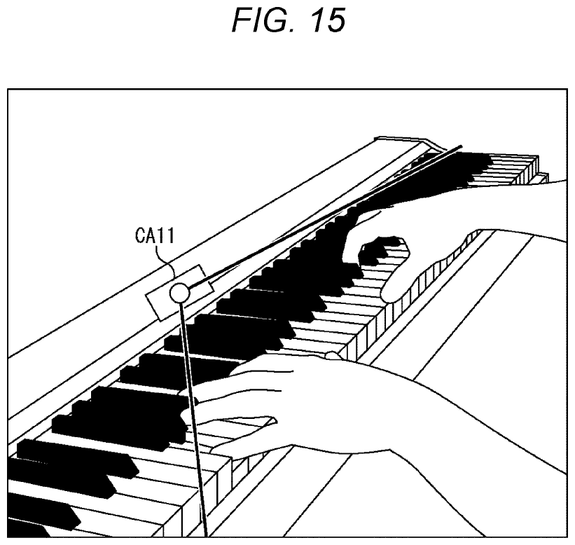

In addition, in the example in FIG. 13, the rocking of the arm (finger) of the user in the lateral direction as the motion may be detected by, as illustrated in FIG. 15 for example, a sensor CA11 such as a camera or an infrared sensor, provided on a portion in front of the user, or the like, at the piano as the musical instrument 11.

For example, in a case where a motion of the user is detected by the camera as the sensor CA11, magnitude of the rocking of the user in the lateral direction is obtained from a moving image captured by the camera on a side of the musical instrument 11 or in the sensing value acquisition unit 22, and a value indicating the magnitude of the rocking is used as a sensing value.

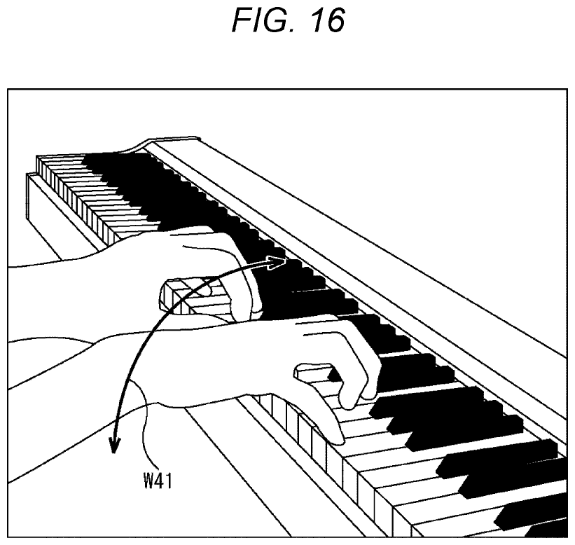

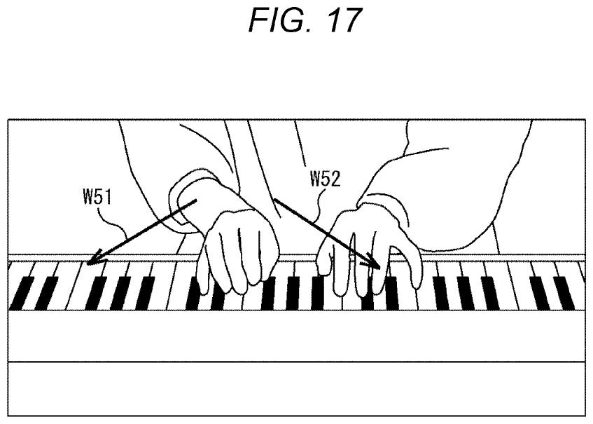

Moreover, for example, as illustrated in FIG. 16, when the user performs an action of rocking an arm of the user in the vertical direction, that is to say the direction indicated by the arrow W41, as a motion while playing a keyboard musical instrument such as a piano as the musical instrument 11, an acoustic effect may be added.

In this case, for example, according to the magnitude of the motion (rocking) of the arm of the user in the vertical direction, a change in a volume level or an effect such as drive, distortion, or resonance (resonance) may be added, as an acoustic effect, to playing sound based on an acoustic signal. At this time, an amount of change in the sound, that is to say intensity of the added acoustic effect, also changes according to the magnitude of the detected swing.

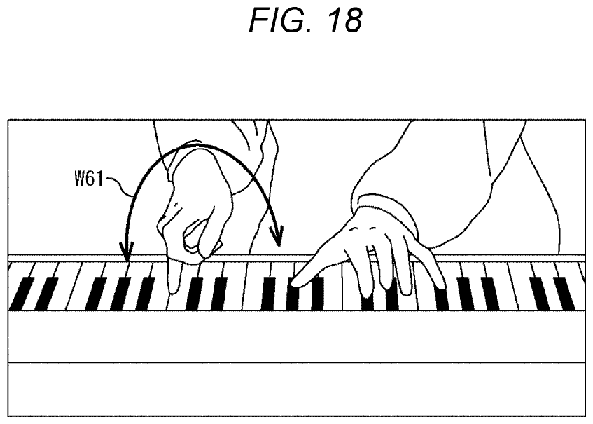

Furthermore, as illustrated in FIG. 17 for example, an acoustic effect may be added in a case where, when playing a keyboard musical instrument such as a piano as the musical instrument 11, the user performs an action of rocking an arm to left or right as indicated by the arrow W51 or arrow W52 as a motion while pressing a keyboard with a finger.

In this case, pitch bend is added as the acoustic effect, and, for example, playing sound of the musical instrument 11 is shifted to a higher note by pitch bend as the user moves the arm to a right side as indicated by the arrow W51, and conversely, the playing sound is shifted to a lower note by pitch bend as the user moves the arm to a left side as indicated by the arrow W52.

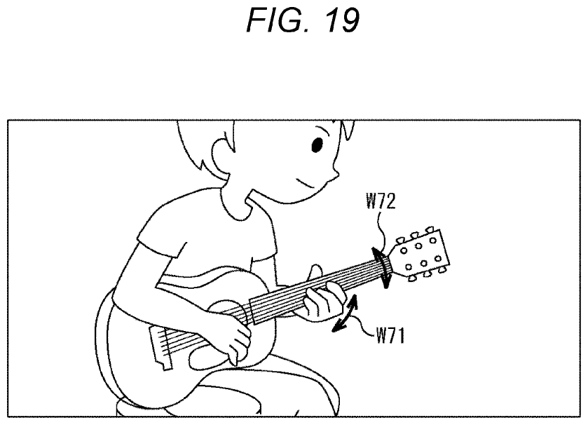

Moreover, as illustrated in FIG. 18 for example, an acoustic effect may be added in a case where, when playing a keyboard musical instrument such as a piano as the musical instrument 11, the user performs an action of turning an arm to right and left as indicated by the arrow W61 as motion while pressing a keyboard with a finger.

In this case, a rotation angle of the arm of the user to the right and left is detected as a sensing value, and, according to the rotation angle, an effect such as pitch bend is added, as an acoustic effect, to the playing sound.

Furthermore, as illustrated in FIG. 19 for example, an acoustic effect such as vibrato or pitch bend may be added in a case where the user performs an action of rocking a string or a head (neck) of a guitar or the like as a motion when playing a string musical instrument such as a guitar as the musical instrument 11.

In this case, for example, when a motion in which the user rocks a hand or a finger while pressing a string as indicated by an arrow W71 or rocks the head up and down as indicated by an arrow W72 is performed as a motion, vibrato or pitch bend is added as an acoustic effect to a playing sound of a guitar or the like.

In this case, for example, the sensing value acquisition unit 22 may acquire a sensing value indicating a motion of a head portion of the guitar or the like from a sensor provided on the guitar or the like as the musical instrument 11, or may acquire the sensing value output from the wearable device 12 as a sensing value indicating the motion of the head portion.

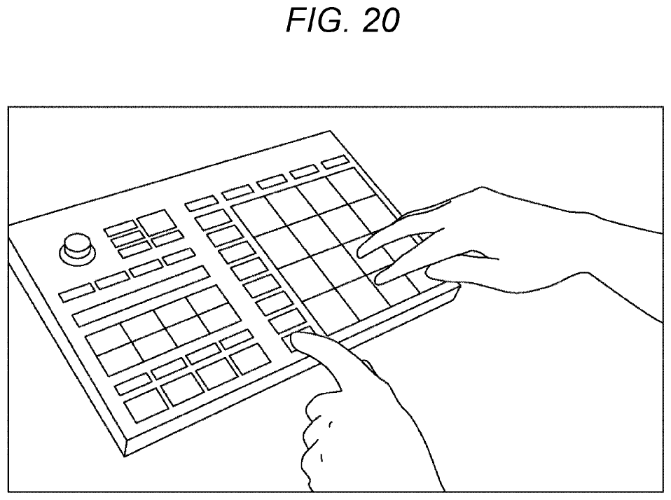

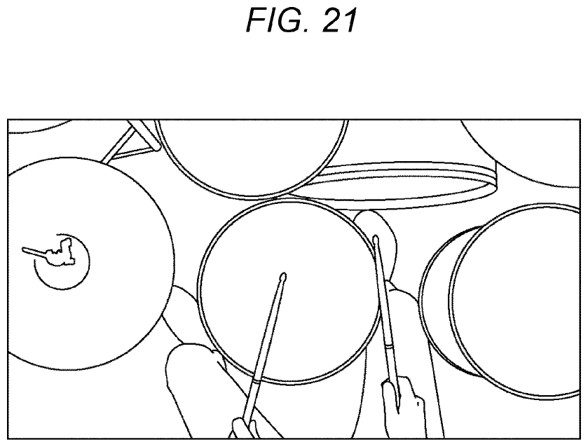

Moreover, as illustrated in FIG. 20 for example, an action of the user pressing a pad (keyboard) of a track pad or keyboard of a keyboard musical instrument, such as a piano, as the musical instrument 11, particularly strength (pressure) of pressing the pad or the keyboard, may be detected as a motion, and an acoustic effect may be added according to the detected pressure.

In this case, not the wearable device 12 but a pressure sensor provided on the pad (keyboard) portion of the musical instrument 11 detects the motion of the user (strength of pressing the pad or the like). Therefore, for example, if the user rocks a hand while pressing the pad portion, pressure applied to the pad portion changes according to the rocking, and therefore intensity of the added acoustic effect also changes.

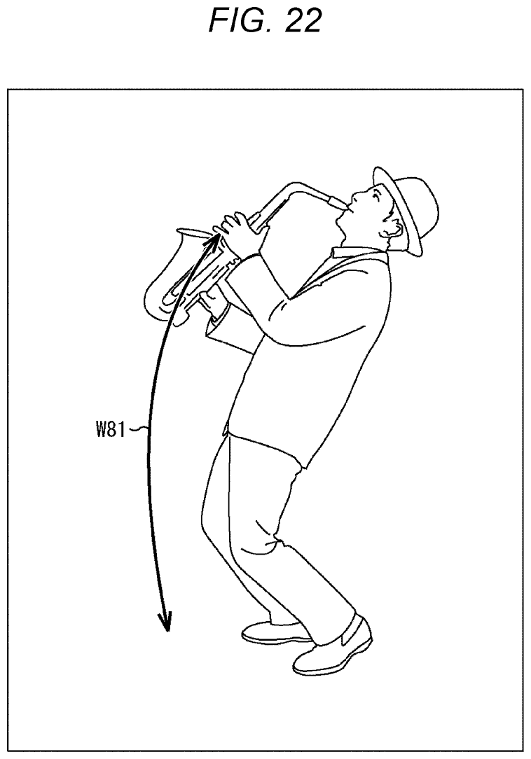

Similarly, for example, as illustrated in FIG. 21, strength (pressure) with which a percussion musical instrument such as a drum is beaten as the musical instrument 11 may be detected by a pressure sensor or the like provided on the percussion musical instrument, and, according to a detection result, an effect (acoustic effect) may be added to sound of playing the drum or the like.

In this case, the playing sound of the drum or the like is collected by a microphone for example, and an acoustic signal obtained as a result can be acquired by the data acquisition unit 21. In this way, the control unit 23 can perform non-linear acoustic processing based on an acoustic parameter on the acoustic signal of sound of playing the drum or the like. Note that, without collecting the sound of playing the drum or the like, an acoustic sound effect having intensity of effect corresponding to the acoustic parameter may be reproduced from the speaker 26 together with the playing sound

Moreover, as illustrated in FIG. 22 for example, an action of the user tilting a wind musical instrument as the musical instrument 11 in a direction indicated by the arrow W81 may be detected as a motion, and, according to a degree of the tilt, an acoustic effect may be added to an acoustic signal of sound of playing the musical instrument 11. In this case, sound of playing the wind musical instrument can be obtained by collecting the sound with a microphone. Furthermore, not only with a wind musical instrument but also with a string musical instrument such as a guitar, a motion of tilting the string musical instrument can be detected as motion.

<About Selection of Sensitivity Curve>

Furthermore, if a plurality of sensitivity curves, that is to say a plurality of conversion functions, is prepared in advance of the parameter calculation unit 31 calculating the acoustic parameter, a desired sensitivity curve can be selected from among the sensitivity curves and utilized for calculation of the acoustic parameter.

For example, in a case where a plurality of sensitivity curves is previously prepared, there are considered a method with which a sensitivity curve preset by default is utilized, a method with which the user selects a sensitivity curve from among the plurality of sensitivity curves, a method with which a sensitivity curve corresponding to a type of a motion is utilized, and the like.

For example, in a case where a sensitivity curve is preset by default for a motion, when the user performs a specific motion, the parameter calculation unit 31 receives, from the sensing value acquisition unit 22, supply of a sensing value corresponding to the motion.

Then, the parameter calculation unit 31 calculates the acoustic parameter on the basis of a conversion function representing a sensitivity curve previously determined, that is to say preset, for the motion performed by the user, and on the basis of the supplied sensing value.

Therefore, in this case, if the user makes a specific motion (motion), sound of playing the musical instrument 11 changes along the preset sensitivity curve, automatically from a viewpoint of the user.

Specifically, for example, when the user performs a motion of rocking the arm, it is assumed that a conversion function representing an exponential function curve is preset for a sensing value indicating the rocking of the arm. In such a case, sensitivity is low when the rocking of the arm is small, and, as the rocking of the arm becomes greater, the sensitivity automatically increases, and a change in sound increases.

<Description of Selection Processing>

Furthermore, in a case where the user selects a sensitivity curve from among the plurality of sensitivity curves, for example, selection processing of selecting a sensitivity curve according to an instruction of the user is performed at a timing of when the instruction is provided by the user.

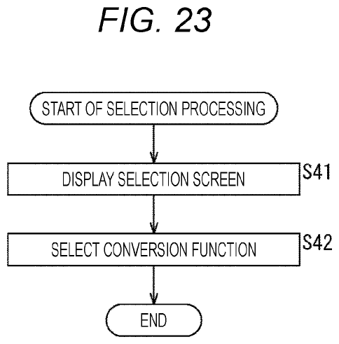

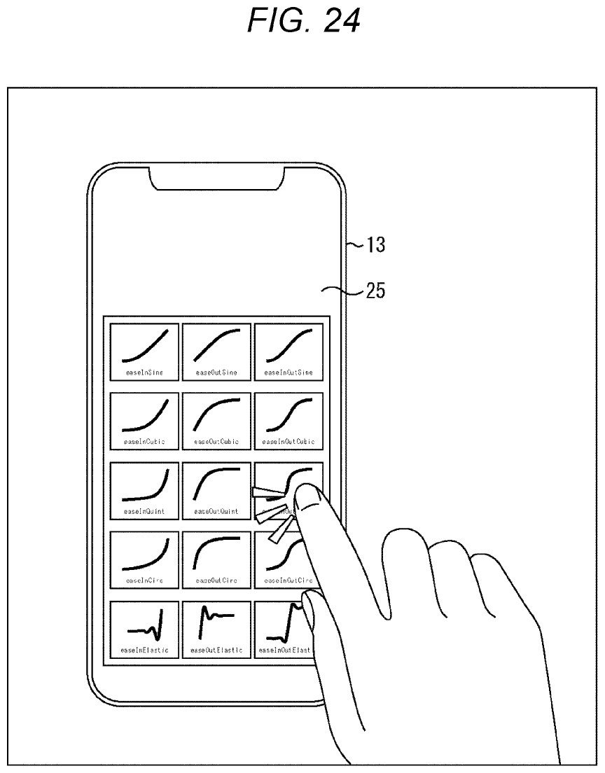

Hereinafter, selection processing performed by the information terminal device 13 will be described with reference to the flowchart in FIG. 23.

In Step S41, by reading image data from an unillustrated memory and supplying the image data to the display unit 25, the control unit 23 displays a selection screen that is a graphical user interface (GUI) based on the image data.

With this arrangement, for example, a selection screen for a sensitivity curve (conversion function) illustrated in FIG. 24 is displayed on the display unit 25.

In the example illustrated in FIG. 24, the selection screen is displayed on the display unit 25, and a plurality of sensitivity curves previously held in the parameter calculation unit 31 and names of these sensitivity curves are displayed as a list on the selection screen.

The user specifies (selects) a desired sensitivity curve from among the plurality of sensitivity curves displayed as a list by touching the desired sensitivity curve with a finger or the like.

In this example, a touch panel as the input unit 24 is superimposed on the display unit 25, and when the user performs touch operation on an area where the sensitivity curve is displayed, a signal corresponding to the touch operation is supplied from the input unit 24 to the control unit 23. Note that the user may be able to select a sensitivity curve for each motion.

Returning to the description of the flowchart in FIG. 23, in Step S42, the control unit 23 selects, on the basis of a signal supplied from the input unit 24, a conversion function representing the sensitivity curve specified by the user from among the plurality of sensitivity curves displayed on the selection screen, as a conversion function to be used for calculation of the acoustic parameter.

When the sensitivity curve, that is to say the conversion function, is selected in this manner, in Step S13 of the reproduction processing in FIG. 5, which is to be performed thereafter, a function output value is obtained by using the conversion function selected in Step S42 in FIG. 23.

When the conversion function is selected by the control unit 23 and information indicating the selection result is recorded by the parameter calculation unit 31 of the control unit 23, the selection processing ends.

As described above, the information terminal device 13 displays the selection screen, and selects a conversion function according to the instruction of the user. In this way, not only the conversion function can be switched according to preference of the user or application intended by the user, but also an acoustic effect can be added along a sensitivity curve desired by the user.

<Description of Selection Processing>

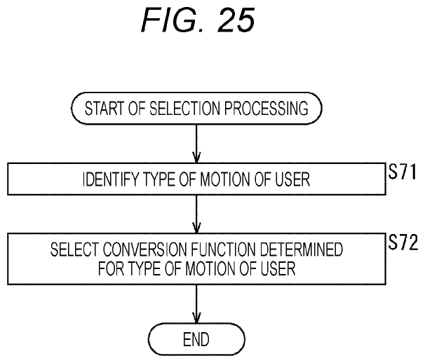

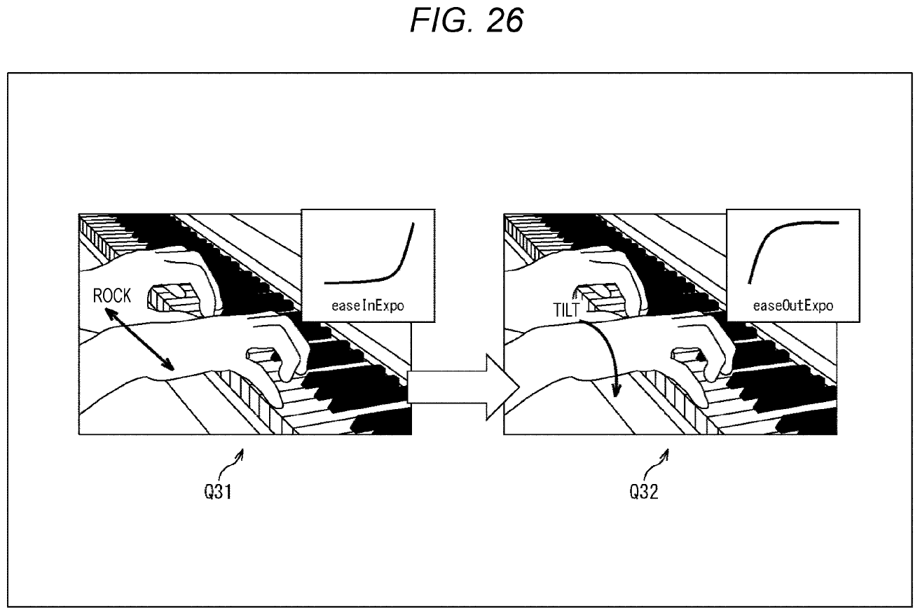

Moreover, in a case where a sensitivity curve corresponding to a type of a motion is selected from among the plurality of sensitivity curves, that is, in a case where a sensitivity curve is changed according to a motion of the user, selection processing illustrated in FIG. 25 is performed as the selection processing.

Hereinafter, selection processing performed by the information terminal device 13 will be described with reference to the flowchart in FIG. 25. Note that the selection processing described with reference to FIG. 25 is started when the sensing value is acquired in Step S12 of the reproduction processing described with reference to FIG. 5.

In Step S71, the parameter calculation unit 31 identifies a type of motion (motion) of the user on the basis of the sensing value supplied from the sensing value acquisition unit 22.

For example, the type of the motion is identified on the basis of a temporal change in the sensing value, information that is supplied together with the sensing value from the wearable device 12 and indicates a type of the sensor that has been used to obtain the sensing value, or the like.

In Step S72, the parameter calculation unit 31 selects a conversion function of a sensitivity curve determined for the type of the motion identified in Step S71 from among the plurality of previously held conversion functions of sensitivity curves, and the selection processing ends.

After the conversion function of the sensitivity curve is selected in this manner, in Step S13 of the reproduction processing in FIG. 5, a function output value is obtained by using the conversion function selected in Step S72.

Note that which type of motion (motion) causes which conversion function of a sensitivity curve to be selected may be previously determined or may be able to be specified by the user.

As described above, from a sensing value or the like, the information terminal device 13 identifies a type of a motion of the user, and selects a sensitivity curve (conversion function) according to the identified result. In this way, an acoustic effect can be added with appropriate sensitivity for each type of motion.

For example, as indicated by the arrow Q31 in FIG. 26, it is assumed that the user is performing a motion (motion) of rocking a hand laterally while playing a piano as the musical instrument 11.

In this case, for example, in the parameter calculation unit 31, a conversion function of a curve called “easeInExpo” is selected as the sensitivity curve in Step S72. In other words, an easeInExponential function is selected as a conversion function.

It is assumed that, from this state, the user stops the motion of lateral rocking of the hand playing, and, as indicated by the arrow Q32 for example, the user performs a motion (motion) of tilting the hand of playing the piano as the musical instrument 11.

Then, in newly performed selection processing in Step S72 in FIG. 25, a conversion function of a curve called “easeOutExpo” is selected as the sensitivity curve. In other words, an easeOutExponential function is selected as the conversion function.

With this arrangement, the conversion function is switched from the easeInExponential function to the easeOutExponential function according to the change in the type of the motion of the user.

In such an example illustrated in FIG. 26, while the user is performing the motion of rocking the hand, sensitivity is low and a change in the playing sound is small with a minute rocking, and when the rocking of the hand becomes greater, the sensitivity gradually increases, and the change in the playing sound also becomes greater.

Conversely, when the user performs a motion (motion) of tilting the hand, the sensitivity is high even if the tilt of the hand of the user is small, and the playing sound changes greatly, whereas in a case where the hand is greatly tilted, the sensitivity gradually decreases, and the change in the playing sound becomes moderate.

Note that, although an example in which a sensitivity curve is selected according to a type of motion of the user has been described here, in addition, a sensitivity curve or acoustic effect may be selected according to a type of the musical instrument 11, a type (genre) of the music, or the like.

For example, the type of the musical instrument 11 may be identified by the control unit 23 being connected to the musical instrument 11 via the data acquisition unit 21 and acquiring information indicating the type (type) of the musical instrument 11 from the musical instrument 11. Furthermore, for example, the control unit 23 may identify the type of the musical instrument 11 by identifying a motion of the user at a time of playing the musical instrument 11 from a sensing value supplied from the sensing value acquisition unit 22.

Moreover, for example, sound based on an acoustic signal to be reproduced, that is, a type (genre) of a music may be identified by the control unit 23 performing various analysis processing on the acoustic signal supplied from the data acquisition unit 21, or may be identified from metadata or the like of the acoustic signal.

<Description of Selection Processing>

In addition, in addition to the user selecting a desired sensitivity curve from the plurality of previously prepared sensitivity curves, the user may specify a desired sensitivity curve by inputting a sensitivity curve by drawing the sensitivity curve, or the like.

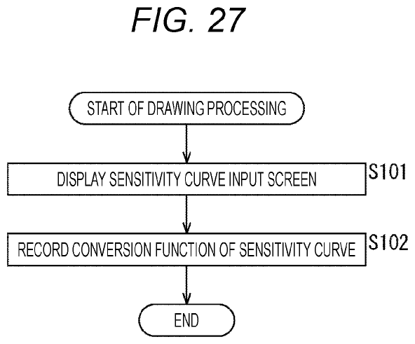

In such a case, drawing processing illustrated in FIG. 27 is performed in the information terminal device 13. Hereinafter, drawing processing by the information terminal device 13 will be described with reference to the flowchart in FIG. 27.

In Step S101, the control unit 23 controls the display unit 25 to display a sensitivity curve input screen for inputting a sensitivity curve on the display unit 25.

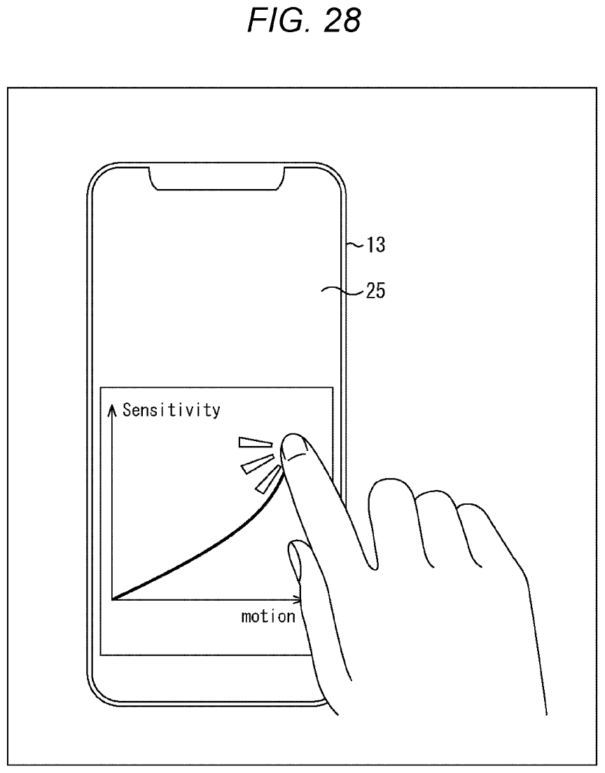

With this arrangement, for example, the sensitivity curve input screen illustrated in FIG. 28 is displayed on the display unit 25.

In the example illustrated in FIG. 28, the user can specify any sensitivity curve by drawing a sensitivity curve with a horizontal axis representing a motion (motion) and a vertical axis representing sensitivity by tracing on the sensitivity curve input screen with a finger or the like.

In this example, a touch panel as the input unit 24 is superimposed on the display unit 25, and the user inputs a desired sensitivity curve such as a non-linear curve or a polygonal line by performing operation of tracing on the sensitivity curve input screen with a finger or the like.

Note that the method for inputting a sensitivity curve is not limited thereto, and any method may be used. Furthermore, for example, a preset sensitivity curve may be displayed on the sensitivity curve input screen, and the user may input a desired sensitivity curve by deforming the sensitivity curve by touch operation or the like.

Returning to the description of the flowchart in FIG. 27, in Step S102, on the basis of a signal supplied from the input unit 24 according to operation of drawing the sensitivity curve by the user, the parameter calculation unit 31 generates and records a conversion function representing the sensitivity curve input by the user When the conversion function of the sensitivity curve drawn by the user is recorded, the drawing processing ends.

As described above, the information terminal device 13 generates and records the conversion function representing the sensitivity curve freely drawn by the user.

With this arrangement, the user can specify a sensitivity curve intended by the user by finely adjusting or customizing sensitivity at a time of operating sound according to a motion of the user, and further can intuitively operate the sound.

### Second Embodiment

<About Addition of Animation Effect>

By the way, in the above, the example has been described in which an acoustic effect is added, in the information terminal device 13, to sound of playing the musical instrument 11 with sensitivity corresponding to a motion of the user.

However, not limited to this, and for example, when a user performs a specific motion (motion), an animation effect may be added as an acoustic effect to sound to be reproduced according to a type of the motion over a certain period of time. Note that, hereinafter, the specific motion (motion) of the user is also particularly referred to as a gesture.

Here, the animation effect is an acoustic effect in which an effect is added, for a certain period of time, to sound to be reproduced along an animation curve obtained by interpolation processing based on a Bezier curve, for example.

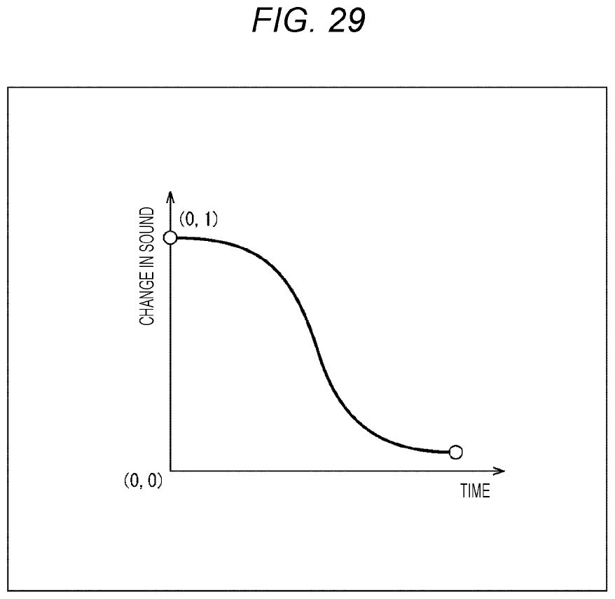

The animation curve can be, for example, a curve as illustrated in FIG. 29. Note that, in FIG. 29, the vertical axis represents a change in sound, and the horizontal axis represents time.

For example, in a case of an animation effect in which a volume level is changed with time, it can be said that the change in sound indicated by a value on the vertical axis of the animation curve represents the volume level.

Hereinafter, a function representing an animation curve is referred to as an animation function. Therefore, the value on the vertical axis of the animation curve, that is to say the value indicating the change in sound is an output value of the animation function (hereinafter, referred to as a function output value).

For example, assuming that the animation effect is an effect that changes a volume level of sound to be reproduced, when the animation effect is added to sound to be reproduced along the animation curve illustrated in FIG. 29, the volume level of the sound to be reproduced decreases with time.

Here, specific examples of a gesture of when an animation effect is added and the animation effect will be described.

For example, in a sensing value acquisition unit 22, a swing of an arm of the user in a lateral direction or vertical direction can be detected as a gesture on the basis of a sensing value, and when the gesture is detected, sound of a sound source previously determined for the gesture, more specifically, a type of the gesture (hereinafter, also referred to as gesture sound) can be reproduced.

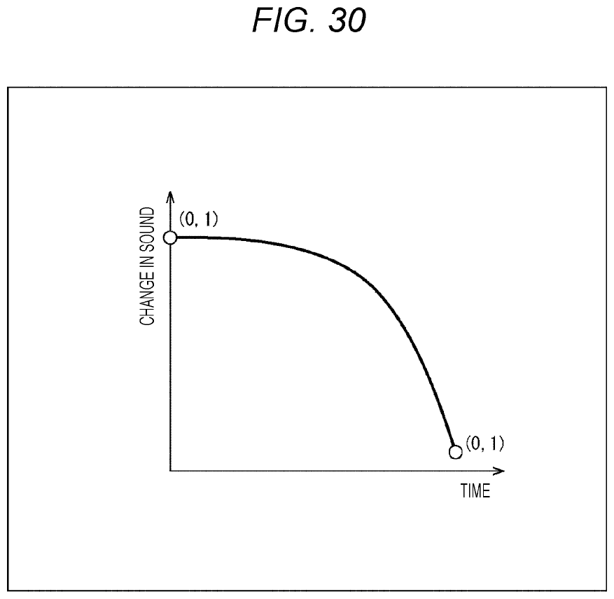

At this time, an animation effect is added in which the volume level of the gesture sound gradually decreases with time, for example, along an animation curve illustrated in FIG. 30. Note that, in FIG. 30, the vertical axis represents a change in sound, that is to say a function output value of an animation function, and the horizontal axis represents time.

In this case, in a control unit 23 for example, an animation curve and acoustic processing, that is to say an animation effect, can be selected according to the detected gesture.

When an animation curve is selected, on the basis of function output value at each time, gain values as acoustic parameters at respective times are calculated in a parameter calculation unit 31. For example, the function output values are subjected to a scale conversion into a scale of an acoustic parameter to be acoustic parameters. Here, the gain values as the acoustic parameters are smaller at a later time (future time).

When the acoustic parameters at the respective times obtained in this manner, in the control unit 23 at each of the times, gain correction is performed on an acoustic signal of the gesture sound as acoustic processing, on the basis of the acoustic parameter at the time, and a reproduction signal is generated.

When sound is reproduced by a speaker 26 on the basis of a reproduction signal obtained in this manner, gesture sound is reproduced such that the volume level decreases with time.

Furthermore, for example, a motion of pressing a keyboard, a motion of plucking a string, or the like may be detected as a motion (gesture) of the user playing a musical instrument 11, and an animation effect may be added to sound of playing the musical instrument 11 along an animation curve corresponding to the motion of the user for a predetermined time.

In this case, the sound of playing the musical instrument 11 may be played as is, and a sound effect to which the animation effect is added according to the motion of the user may be reproduced together with the playing sound.

<Description of Reproduction Processing>

Moreover, in the sensing value acquisition unit 22 for example, on the basis of sensing values indicating a motion of the user acquired at each of the times, peak values of time waveforms of those sensing values may be sequentially detected, and an initial value of an acoustic parameter may be determined according to the detected peak values.

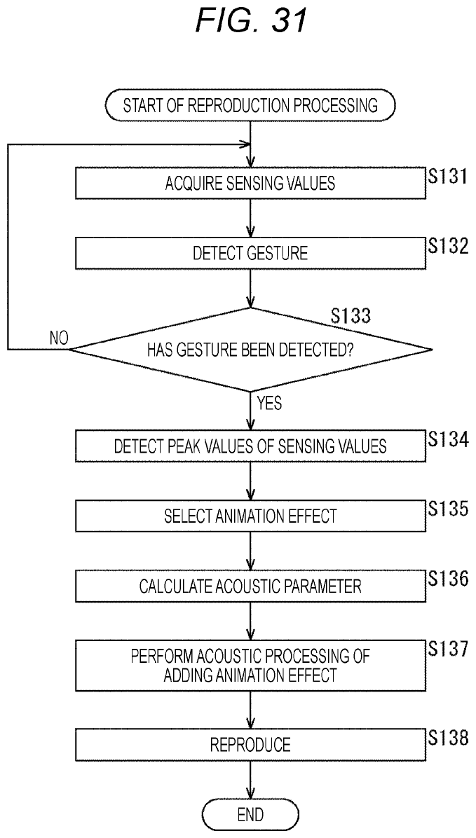

In such a case, in the information terminal device 13 for example, reproduction processing illustrated in FIG. 31 is performed, for example. Hereinafter, reproduction processing by the information terminal device 13 will be described with reference to the flowchart in FIG. 31.

In Step S131, the sensing value acquisition unit 22 acquires sensing values indicating a motion (motion) of the user by receiving the sensing values from a wearable device 12 by wireless communication or the like.

In Step S132, on the basis of the sensing values acquired so far, the sensing value acquisition unit 22 detects whether or not a specific gesture is performed by the user.

In Step S133, the sensing value acquisition unit 22 decides whether or not a gesture has been detected as a result of the detection in Step S132.

In a case where it is decided in Step S133 that no gesture has been detected, the processing returns to Step S131, and the above-described processing is repeatedly performed.

Meanwhile, in a case where it is decided in Step S133 that a gesture has been detected, in Step S134, the sensing value acquisition unit 22 detects wave-shaped peak values of the sensing values on the basis of the sensing values in a latest predetermined period that are acquired so far.

The sensing value acquisition unit 22 supplies the parameter calculation unit 31 with information indicating the gesture and peak values detected in this manner.

In Step S135, the parameter calculation unit 31 determines an animation effect, that is to say an animation curve, and acoustic processing on the basis of the detected information indicating the gesture and peak values supplied from the sensing value acquisition unit 22.

Here, for example, it is assumed that an animation effect and gesture sound to be reproduced are previously determined for a type of gesture, that is to say a motion of the user. In this case, the parameter calculation unit 31 selects an animation effect previously determined for the detected gesture, as an animation effect to be added to the gesture sound.

Furthermore, at this time, the control unit 23 controls the data acquisition unit 21 to acquire an acoustic signal of the gesture sound previously determined for the detected gesture.

Note that, although a case where sound to be reproduced is gesture sound determined for a gesture will be described here, not limited to this, an animation effect can be added to any sound such as sound of playing the musical instrument 11.

In Step S136, the parameter calculation unit 31 calculates an acoustic parameter on the basis of the detected information indicating the gesture and peak values, the information being supplied from the sensing value acquisition unit 22.

In this case, for example, the parameter calculation unit 31 calculates an initial value of the acoustic parameter by performing scale conversion on the peak values of the sensing values into a scale of the acoustic parameters.

The initial value of the acoustic parameter here is a value of the acoustic parameter at a time point of starting the animation effect to be added to the gesture sound.

Furthermore, on the basis of the initial value of the acoustic parameters and the animation curve for achieving the animation effect determined in Step S135, the parameter calculation unit 31 calculates acoustic parameters at the respective times within a period for adding an animation effect to gesture sound.

Here, values of the acoustic parameters at the respective times are calculated on the basis of the initial value of the acoustic parameters and function output values at the respective times for an animation function representing an animation curve, so that a value of the acoustic parameter gradually changes from the initial value along the animation curve.

Note that, hereinafter, a period in which the animation effect is added is also particularly referred to as an animation period.

In Step S137, the control unit 23 generates a reproduction signal by performing acoustic processing of adding the animation effect on the acoustic signal of the gesture sound on the basis of the acoustic parameters at the respective times, the acoustic parameter being calculated in Step S136.

That is to say, the control unit 23 generates the reproduction signal by performing, on the acoustic signal of the gesture sound, acoustic processing based on the acoustic parameter, while gradually changing the values of the acoustic parameters from the initial values along the animation curve.

Therefore, because the acoustic parameters change with time in this case, non-linear acoustic processing is performed on the acoustic signal.

In Step S138, the control unit 23 supplies the speaker 26 with the reproduction signal obtained in Step S137 to reproduce sound, and the reproduction processing ends.

With this arrangement, gesture sound to which an animation effect corresponding to the gesture is added is reproduced in the speaker 26.

As described above, the information terminal device 13 calculates the acoustic parameters on the basis of the peak values of the sensing values, and performs non-linear acoustic processing on the acoustic signal on the basis of the acoustic parameter.

In this way, the user can add a desired animation effect to the gesture sound only by making a predetermined gesture. Therefore, the user can intuitively operate sound.

Here, a specific example of the above-described case where an animation effect corresponding to a gesture is added will be described.

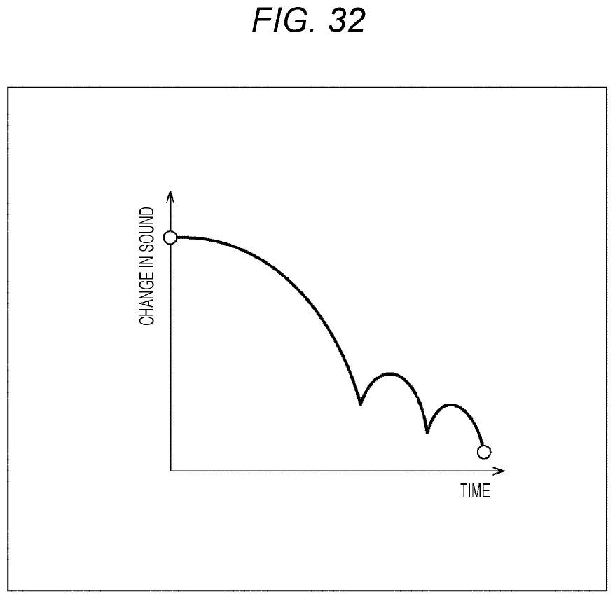

As such an example, it is conceivable that, in a case where the user makes a gesture of swinging an arm for example, a Bounce animation with an animation curve as illustrated in FIG. 32 is added to gesture sound, in which volume of the gesture sound gradually decreases.

Note that, in FIG. 32, the vertical axis represents a change in sound, that is to say a function output value of an animation function, and the horizontal axis represents time.

The animation curve illustrated in FIG. 32 is a curve in which the sound gradually decreases with time while changing up and down.

Therefore, provided that jerk of when the user swings an arm is acquired as a sensing value for example, wave-shaped peak values of the jerk as sensing values are detected in the sensing value acquisition unit 22.

Furthermore, in the parameter calculation unit 31, gain values as the acoustic parameters, that is, initial values of volume at a time of reproducing gesture sound are determined on the basis of the peak values of the jerk, and the acoustic parameters at the respective times are determined such that the acoustic parameters change along the animation curve illustrated in FIG. 32.

Then, in the control unit 23, on the basis of the determined acoustic parameters at the respective times, that is to say the gain values, gain correction as acoustic processing is performed on an acoustic signal of the gesture sound, and as a result, a Bounce animation effect is added to the gesture sound.

In this case, due to the Bounce animation effect, gesture sound is reproduced in which volume of sound generated according to the gesture of the user, that is, the swing of the arm, gradually decreases with time by changing as if the sound bounces by hitting an object and bounds.

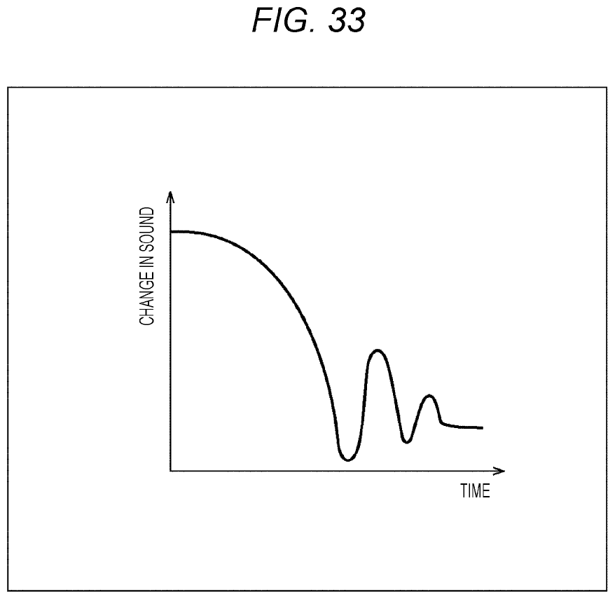

In addition, it is also conceivable to add an Elastic animation with an animation curve as illustrated in FIG. 33 for example, to the gesture sound. Note that, in FIG. 33, the vertical axis represents a change in sound, that is to say a function output value of an animation function, and the horizontal axis represents time.

When the volume of the gesture sound is changed along such an animation curve illustrated in FIG. 33, an effect with which sound generated according to a gesture (gesture sound) returns as if with elasticity can be added to the gesture sound.

Moreover, for example, acceleration or the like indicating vibration of when a percussion musical instrument as the musical instrument 11 is beaten may be acquired as a sensing value, and various effects such as reverb or delay may be animated by using the peak values of the sensing values indicating a vibration waveform, similarly to the above-described example.

In such a case, a degree of application of the acoustic effect, such as reverb or delay, added to the sound of playing the musical instrument 11 or the like changes with time along the animation curve.

<First Modification of Second Embodiment>

<About Addition of Animation Effect>

Moreover, for example, gesture sound may be generated according to the motion (gesture) of the user, and an animation effect may be added to the gesture sound, that is to say a waveform of the sound.

For example, it is assumed that acceleration indicating a motion of the user is detected as sensing values, and, according to the sensing values, an acoustic signal having a sound waveform having a specific frequency, such as a sine wave, is generated as a signal of gesture sound.

In such a case, it is conceivable that an initial value of the acoustic parameter is determined similarly to the above-described example, and an animation effect in which a degree of application of the effect changes with time along a predetermined animation curve is added to the gesture sound.

Furthermore, for example, it is also conceivable to add an animation effect having a specific waveform to aerodynamic sound generated by the motion of the user.

In such a case, for example, sound pressure or the like of the aerodynamic sound is detected as a sensing value, an initial value of the acoustic parameters is determined on the basis of the wave-shaped peak values of the sensing value, and acoustic processing based on the acoustic parameter at each time is performed on an acoustic signal of the aerodynamic sound obtained by sound collection.

<Second Modification of Second Embodiment>

<About Addition of Animation Effect>

Moreover, in a case where an animation effect is added according to a motion of the user, the animation effect may be added again when a great motion of the user is newly detected before an animation ends.

For example, it is assumed that initial value of the acoustic parameters is determined according to the peak values of the sensing values indicating the motion of the user, and an animation effect for changing a degree of application of the effect is added to an acoustic signal on the basis of the initial value and an animation curve.

Here, although sound based on the acoustic signal may be any sound such as sound of playing the musical instrument 11 or a sound effect determined for a motion of the user, here, it is assumed that sound of playing the musical instrument 11 is reproduced.

At this time, assuming that acceleration of a predetermined portion of a body of the user is detected as a sensing value for example, an initial value of the acoustic parameters is determined on the basis of a peak value of the acceleration.

Furthermore, when the initial value of the acoustic parameter is determined, values of the acoustic parameters at respective subsequent times are determined such that values of the acoustic parameters change along an animation curve determined for the motion of the user or the like.

When the acoustic parameters at the respective times including the initial value are determined in this manner, acoustic processing is performed on an acoustic signal to be reproduced on the basis of the acoustic parameters at the respective times, and a reproduction signal is generated. Then, when sound is reproduced on the basis of the reproduction signal obtained in this manner, an animation effect for a certain period of time is added to the sound of playing the musical instrument 11 and reproduced.

In this case, in a case where an acoustic parameter obtained for a peak value of the acceleration indicating a motion of the user (sensing value) exceeds an acoustic parameter at a current time before the animation period ends, the acoustic parameter obtained for the peak value is set as a new initial value.

That is to say, in a case where the acoustic parameter obtained from the peak value at an arbitrary time in the animation period is greater than an actual acoustic parameter at that time, the acoustic parameter obtained for the peak value at that time is set as an initial value of the new acoustic parameter, and the animation effect is newly added to the sound of playing the musical instrument 11.

Note that, although the example of adding an animation effect to sound of playing the musical instrument 11 has been described here, a similar can be applied to other cases, for example, a case of adding an animation effect to aerodynamic sound generated by a motion of the user, or the like.

<Description of Reproduction Processing>

Here, as described above, there will be described processing performed in a case where an initial value of the acoustic parameter is updated as appropriate according to a motion of the user, and an animation effect is newly added.

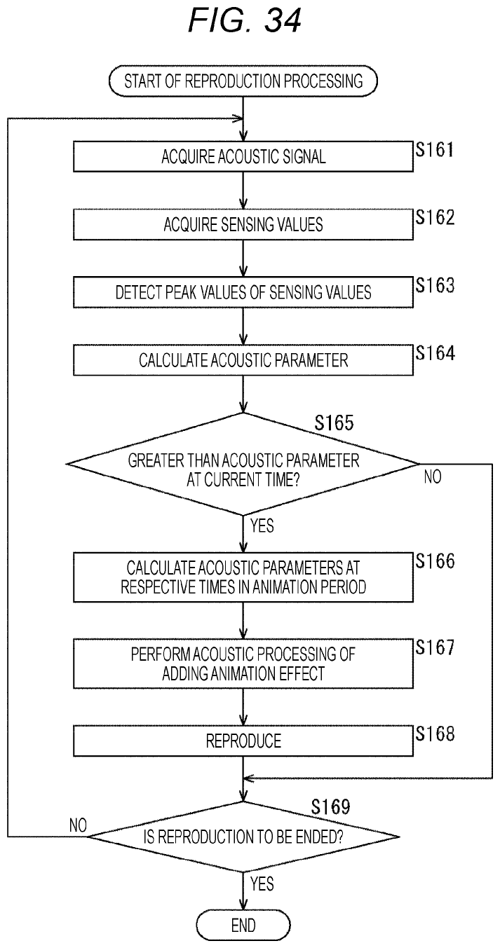

That is to say, hereinafter, reproduction processing by the information terminal device 13 will be described with reference to the flowchart in FIG. 34.

Note that, here, a case where an animation effect is added to sound of playing the musical instrument 11 when the user makes a predetermined motion will be described as an example.

In Step S161, the data acquisition unit 21 acquires an acoustic signal output from the musical instrument 11 and supplies the acoustic signal to the control unit 23.

In Step S162, a sensing value acquisition unit 22 acquires a sensing value indicating a motion (motion) of the user by receiving a sensing value from the wearable device 12 by wireless communication or the like.

In Step S163, the sensing value acquisition unit 22 detects the wave-shaped peak values of the sensing values on the basis of the sensing values in a latest predetermined period that are acquired so far.

The sensing value acquisition unit 22 supplies the parameter calculation unit 31 with the peak value of the sensing value detected in this manner.

In Step S164, the parameter calculation unit 31 calculates the acoustic parameter on the basis of the peak value, the information being supplied from the sensing value acquisition unit 22.

In this case, for example, the parameter calculation unit 31 calculates an initial value of the acoustic parameter by performing scale conversion on the peak values of the sensing values into a scale of the acoustic parameters.

In Step S165, the parameter calculation unit 31 decides whether or not the initial value of the acoustic parameters calculated in Step S164 is greater than the acoustic parameter at the current time.

For example, it is assumed that, when the user makes a predetermined motion, an animation effect previously determined for the motion is added to the sound of playing the musical instrument 11.

At this time, in a case where it is not the animation period, if the initial value of the acoustic parameters obtained in Step S164 is greater than 0, it is decided in Step S165 that the initial value is greater than the acoustic parameter at the current time.

Furthermore, in a case where it is the animation period, if the initial value of the acoustic parameters obtained in Step S164 is greater than the acoustic parameter at the current time actually used for adding the animation effect, it is decided in Step S165 that the initial value is greater than the acoustic parameter at the current time.

In a case where it is decided in Step S165 that the initial value of the acoustic parameters is not greater than the acoustic parameter at the current time, the processing in Step S166 to Step S168 is not performed, and thereafter, the processing proceeds to Step S169.

In this case, if it is not the animation period, the control unit 23 supplies the speaker 26 with an acoustic signal, to which an acoustic effect, that is to say an animation effect, is not added, as is as a reproduction signal, and reproduces the sound of playing the musical instrument 11.

Furthermore, if it is the animation period, acoustic processing is performed on the acoustic signal on the basis of the acoustic parameter of the current time, and sound is reproduced by the speaker 26 on the basis of the obtained reproduction signal. In this case, the playing sound to which the animation effect is added is reproduced.

Meanwhile, in a case where it is decided in Step S165 that the initial value of the acoustic parameters is greater than the acoustic parameter at the current time, thereafter, the processing proceeds to Step S166.

In this case, regardless of whether or not an animation effect is currently added to the sound of playing the musical instrument 11, that is, regardless of whether or not it is the animation period, acoustic parameters at respective times in the new animation period are calculated on the basis of the initial value of the acoustic parameters calculated in Step S164, and the animation effect is newly added to the sound of playing the musical instrument 11.

In Step S166, the parameter calculation unit 31 calculates the acoustic parameters at the respective times in the animation period on the basis of the initial value of the acoustic parameters calculated in Step S164 and an animation curve determined for the motion of the user or the like.

Here, the values of the acoustic parameters are calculated on the basis of the initial value of the acoustic parameters and function output values at the respective times for an animation function representing an animation curve, so that values of the acoustic parameters gradually change from the initial value along the animation curve.

In Step S167, the control unit 23 generates a reproduction signal by performing acoustic processing of adding an animation effect on the acoustic signal acquired by the data acquisition unit 21 on the basis of the acoustic parameters at the respective times, the acoustic parameter being calculated in Step S166.

That is to say, the control unit 23 generates the reproduction signal by performing, on the acoustic signal, acoustic processing based on the acoustic parameters, while gradually changing the values of the acoustic parameters from the initial value along the animation curve.

In Step S168, the control unit 23 supplies the speaker 26 with the reproduction signal obtained in Step S167 to reproduce sound. With this arrangement, a new animation period is started, and an animation effect is added to the sound of playing the musical instrument 11 and reproduced.

If the processing in Step S168 is performed, or it is decided in Step S165 that the acoustic parameter is not greater than the acoustic parameter at the current time, the control unit 23 decides in Step S169 whether or not to end reproduction of sound based on the acoustic signal.

For example, in Step S169, in a case where the user ends playing the musical instrument 11, or the like, it is decided to end the reproduction.

In a case where it is decided in Step S169 that the reproduction is not yet to be ended, the processing returns to Step S161, and the above-described processing is repeatedly performed.

Meanwhile, in a case where it is decided in Step S169 that the reproduction is to be ended, each of the units of the information terminal device 13 stops processing being performed, and the reproduction processing ends.

As described above, the information terminal device 13 calculates the acoustic parameters on the basis of the peak values of the sensing values, and performs acoustic processing on the acoustic signal on the basis of the acoustic parameters.

Furthermore, when there is a motion of the user in which the value of the acoustic parameter is larger than the value of the acoustic parameter of the current time in the animation period, the information terminal device 13 newly adds an animation effect to the sound of playing the musical instrument 11 according to the motion.

In this way, the user can add a desired animation effect according to a motion of the user. Therefore, the user can intuitively operate sound.

<Configuration Example of Computer>

By the way, the above-described series of processing can be executed by hardware or can be executed by software. In a case where a series of processing is executed by software, a program constituting the software is installed on the computer. Here, the computer includes, a computer incorporated in dedicated hardware, a general-purpose personal computer for example, which is capable of executing various kinds of functions by installing various programs, or the like.

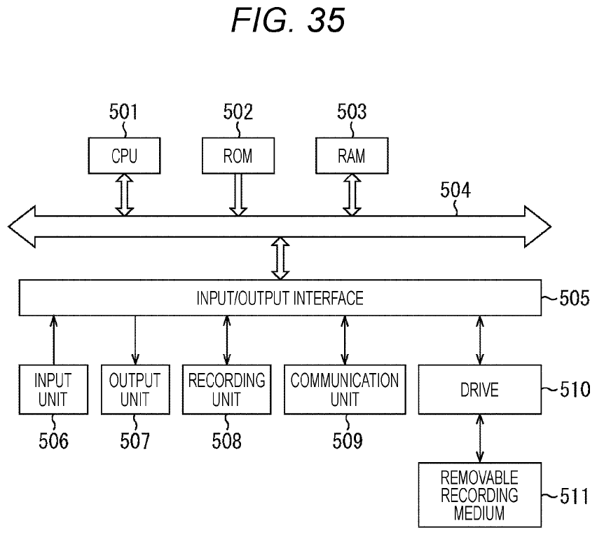

FIG. 35 is a block diagram illustrating a configuration example of hardware of a computer that executes the above-described series of processing with a program.

In the computer, a central processing unit (CPU) 501, a read only memory (ROM) 502, and a random access memory (RAM) 503 are mutually connected by a bus 504.

Moreover, an input/output interface 505 is connected to the bus 504. An input unit 506, an output unit 507, a recording unit 508, a communication unit 509, and a drive 510 are connected to the input/output interface 505.

The input unit 506 includes a keyboard, a mouse, a microphone, an image sensor, or the like. The output unit 507 includes a display, a speaker, or the like. The recording unit 508 includes a hard disk, a non-volatile memory, or the like. The communication unit 509 includes a network interface, or the like. The drive 510 drives a removable recording medium 511 such as a magnetic disk, an optical disk, a magneto-optical disk, or a semiconductor memory.

In the computer configured as above, the series of processing described above is executed by the CPU 501 loading, for example, a program recorded in the recording unit 508 to the RAM 503 via the input/output interface 505 and the bus 504 and executing the program.

A program executed by the computer (CPU 501) can be provided by being recorded on the removable recording medium 511 as a package medium, or the like, for example. Furthermore, the program can be provided via a wired or wireless transmission medium such as a local area network, the Internet, or digital satellite broadcasting.

In the computer, the program can be installed on the recording unit 508 via the input/output interface 505 by attaching the removable recording medium 511 to the drive 510. Furthermore, the program can be received by the communication unit 509 via the wired or wireless transmission medium and installed on the recording unit 508. In addition, the program can be installed on the ROM 502 or the recording unit 508 in advance.

Note that, the program executed by the computer may be a program that is processed in time series in an order described in this specification, or a program that is processed in parallel or at a necessary timing such as when a call is made.

Furthermore, embodiments of the present technology are not limited to the above-described embodiments, and various changes can be made without departing from the scope of the present technology.

For example, the present technology can have a configuration of cloud computing in which one function is shared and processed jointly by a plurality of devices via a network.

Furthermore, each step described in the above-described flowcharts can be executed by one device, or can be executed by being shared by a plurality of devices.

Moreover, in a case where a plurality of pieces of processing is included in one step, the plurality of pieces of processing included in the one step can be executed by being shared by a plurality of devices, in addition to being executed by one device.

Moreover, the present technology may have the following configurations.

(1)

A signal processing device including:

an acquisition unit that acquires a sensing value indicating a motion of a predetermined portion of a body of a user or motion of an instrument; and

a control unit that performs non-linear acoustic processing on an acoustic signal according to the sensing value.

(2)

The signal processing device according to (1),

in which the control unit performs the acoustic processing on the basis of a parameter that changes non-linearly according to the sensing value.

(3)

The signal processing device according to (2),

in which the control unit calculates the parameter corresponding to the sensing value on the basis of a conversion function having a non-linear curve or polygonal line, the conversion function being input by a user.

(4)

The signal processing device according to (2),

in which the control unit calculates the parameter on the basis of a conversion function selected, by a user, from among a plurality of the conversion functions for obtaining the parameter from the sensing value.

(5)

The signal processing device according to (2),

in which the control unit selects a conversion function determined for a type of the motion from among from among a plurality of the conversion functions for obtaining the parameter from the sensing value, and calculates the parameter on the basis of the selected conversion function.

(6)

The signal processing device according to (1),

in which the control unit adds an animation effect to the acoustic signal with the acoustic processing.

(7)

The signal processing device according to (6)

in which the control unit adds, to the acoustic signal, the animation effect determined for a type of the motion.

(8)

The signal processing device according to (6) or (7),

in which the control unit adds the animation effect to the acoustic signal by obtaining an initial value of a parameter of the acoustic processing on the basis of a wave-shaped peak value of the sensing value, and performing the acoustic processing while changing the parameter from the initial value.

(9)

The signal processing device according to (8),

in which, in a case where, at an arbitrary time in an animation period during which the animation effect is performed, the parameter corresponding to the peak value at the time is greater than actual the parameter at the time, the control unit performs the acoustic processing so that the animation effect is newly added to the acoustic signal on the basis of the initial value obtained on the basis of the peak value at the time.

(10)

The signal processing device according to any one of (1) to (9),

in which the acoustic signal includes a signal of sound of playing a musical instrument played by a user.

(11)

The signal processing device according to any one of (1) to (9),

in which the acoustic signal includes a signal determined for a type of the motion.

(12)

A signal processing method including:

by a signal processing device,

acquiring a sensing value indicating a motion of a predetermined portion of a body of a user or motion of an instrument; and

performing non-linear acoustic processing on an acoustic signal according to the sensing value.

(13)

A program that causes a computer to execute processing including steps of:

acquiring a sensing value indicating a motion of a predetermined portion of a body of a user or motion of an instrument; and

performing non-linear acoustic processing on an acoustic signal according to the sensing value.

### REFERENCE SIGNS LIST

11 Musical instrument
12 Wearable device
13 Information terminal device
21 Data acquisition unit
22 Sensing value acquisition unit
23 Control unit
24 Input unit
25 Display unit
26 Speaker
31 Parameter calculation unit

1. A signal processing device comprising:
an acquisition unit that acquires a sensing value indicating a motion of a predetermined portion of a body of a user or motion of an instrument; and
a control unit that performs non-linear acoustic processing on an acoustic signal according to the sensing value.

2. The signal processing device according to claim 1,
wherein the control unit performs the acoustic processing on a basis of a parameter that changes non-linearly according to the sensing value.

3. The signal processing device according to claim 2,
wherein the control unit calculates the parameter corresponding to the sensing value on a basis of a conversion function having a non-linear curve or polygonal line, the conversion function being input by a user.

4. The signal processing device according to claim 2,
wherein the control unit calculates the parameter on a basis of a conversion function selected, by a user, from among a plurality of the conversion functions for obtaining the parameter from the sensing value.

5. The signal processing device according to claim 2,
wherein the control unit selects a conversion function determined for a type of the motion from among from among a plurality of the conversion functions for obtaining the parameter from the sensing value, and calculates the parameter on a basis of the selected conversion function.

6. The signal processing device according to claim 1,
wherein the control unit adds an animation effect to the acoustic signal with the acoustic processing.

7. The signal processing device according to claim 6,
wherein the control unit adds, to the acoustic signal, the animation effect determined for a type of the motion.

8. The signal processing device according to claim 6,
wherein the control unit adds the animation effect to the acoustic signal by obtaining an initial value of a parameter of the acoustic processing on a basis of a wave-shaped peak value of the sensing value, and performing the acoustic processing while changing the parameter from the initial value.

9. The signal processing device according to claim 8,
wherein, in a case where, at an arbitrary time in an animation period during which the animation effect is performed, the parameter corresponding to the peak value at the time is greater than actual the parameter at the time, the control unit performs the acoustic processing so that the animation effect is newly added to the acoustic signal on a basis of the initial value obtained on a basis of the peak value at the time.

10. The signal processing device according to claim 1,
wherein the acoustic signal includes a signal of sound of playing a musical instrument played by a user.

11. The signal processing device according to claim 1,
wherein the acoustic signal includes a signal determined for a type of the motion.

12. A signal processing method comprising:
by a signal processing device,
acquiring a sensing value indicating a motion of a predetermined portion of a body of a user or motion of an instrument; and
performing non-linear acoustic processing on an acoustic signal according to the sensing value.

13. A program that causes a computer to execute processing comprising steps of:
acquiring a sensing value indicating a motion of a predetermined portion of a body of a user or motion of an instrument; and
performing non-linear acoustic processing on an acoustic signal according to the sensing value.
